(19) United States
(12) Patent Application Publication
(10) Pub. No.: US 2024/0255394 A1
(43) Pub. Date: Aug. 1, 2024

(54) SLIDE STAINING DEVICE

(71) Applicant: Calamat LTD, Stockport (GB)

(72) Inventors: David Charles MANGHAM, Stockport (GB); Sara Isabela Barbosa CARNEIRO, Stockport (GB)

(21) Appl. No.: 18/559,289

(22) PCT Filed: May 4, 2022
(86) PCT No.: PCT/GB2022/051128

§ 371 Date: Nov. 6, 2023

(30) Foreign Application Priority Data
May 10, 2021 (GB) 2106652.7
Mar. 18, 2022 (GB) 2203782.4

(51) Int. Cl. G01N 1/30; B01L 9/00; G01N 1/31

(52) U.S. Cl. CPC G01N 1/30; B01L 9/52; G01N 1/312; G01N 2001/302

(57) ABSTRACT

This application relates to a coverplate assembly for a microscope slide, the coverplate comprising: a coverplate body; at least two flanges arranged on a surface of the coverplate body; and a magnet or a magnetic material configured to cooperate with a magnetic counterpart to affix the coverplate to a microscope slide, thereby providing a capillary gap between the coverplate body and the microscope slide. Also described is: An apparatus for preparing a plurality of microscope slides, the apparatus comprising: a frame; and a rotatable member connected to, and rotatable relative to, the frame; wherein the rotatable member is rotatable between a first position and a second position about a rotational axis; and wherein the rotatable member comprises a slide fastener to affix the plurality of microscope slides to the rotatable member, and: A method of preparing a plurality of microscope slides, the method comprising the steps of: (a) optionally applying one or more samples to the plurality of microscope slides; (b) mounting the plurality of microscope slides on a rotatable member, the rotatable member being rotatable between a first position and a second position about a rotational axis; (c) applying one or more treatment liquids to the plurality of microscope slides in the first position; and (d) rotating the rotatable member to a second position to effect removal of the one or more treatment liquids; (e) optionally drying the plurality of microscope slides; (f) optionally repeating steps one or more of steps (c) to (e); (g) optionally applying sealant to the plurality of microscope slides; (h) optionally removing the plurality of microscope slides from the rotatable member; wherein the rotatable member comprises a fastener to affix the plurality of microscope slides to the rotatable member.

### FIELD OF THE INVENTION

The present invention relates to a coverplate for a microscope slide, and an apparatus and method for preparing a plurality of microscope slides.

### BACKGROUND TO THE INVENTION

The staining of biological samples—e.g., tissue sections, cell preparations—adhered to microscope slides is widespread in histology and cytology laboratories and life science research laboratories. Various types of reagents are used to stain biological samples in order to ascertain the presence or absence of molecules in the biological sample and, when present, to determine their distribution in cells and tissue. Whereas many dyes (e.g., haematoxylin, eosin) are of relatively low cost and can be applied liberally to the biological samples, other reagents are more expensive (e.g., antibodies, DNA probes) and are used in small amounts to minimize costs. An example of the latter is immunohistochemistry/immunocytochemistry—a technique that applies expensive specific antibodies, sequentially, to detect the presence and distribution of target proteins or other molecules in biological samples (such as tissue/cell preparations) mounted on microscope slides.

Typically, such reagents are applied to the slide-mounted biological preparations in volumes of between 100 microlitres and 250 microlitres. In order to minimize the volume of applied reagents in immunohistochemistry/immunocytochemistry, reagent is applied to horizontal slide-mounted biological samples (“flat-bed method”) or a thin gap is created between the sample-bearing microscope slide and a coverplate to create a thin gap which will hold and spread a reagent in contact with the mounted biological sample by capillary action/surface tension. A commonly used apparatus to achieve low volume reagent use (100 microlitres) by capillary action/surface tension is the Shandon Sequenza apparatus (U.S. Pat. No. 4,985,206).

Microscope slides for holding samples, such as tissue sections, have been available for over one hundred and fifty years. To analyze the samples, it is common to prepare the slides using a staining protocol, such as the Haematoxylin and Eosin (H&E) staining protocol used in histology. These staining protocols often require multiple reagents to be added and removed from the slides in turn. For example, a staining protocol will commonly require a dewaxing step, a dehydrating step, one or more staining steps, a dehydration step and a clearing step. Repeatedly applying and removing reagents to a number of microscope slides is arduous, time consuming, and can result in the slides being over- or under-stained.

Slide staining jars, such as Coplin jars, are known in the art and allow multiple slides (e.g. up to 10 slides) to be dipped or placed into a reagent contained within the jar. Often, these jars have internal grooves to separate the slides within the jar. When the incubation period for a given reagent has ended, this reagent is poured out and replaced with a rinse solution or another reagent, allowing the entire group of slides to be treated simultaneously. Alternatively, multiple slides can be mounted on a slide rack and the slide rack moved between different containers of different reagents. In both cases, a large volume of each reagent is required to fill the containers such that the samples present on the slides are fully immersed in the reagent.

Different techniques for the automation of slide staining are known in the art. One such technique is to provide a row of containers of reagent, and to automate the movement of a slide rack or basket between the containers of reagent. For example, a slide rack is lowered into a first container, raised from the first container, moved to above a second container, lowered into the second container, and so forth. Examples of such automated machines are the Myreva Automated Slide Stainer SS-30 and the Leica ST5010 AutoStainer™. Again, this technique requires a large volume of each reagent to fill the containers.

Another technique is to provide slides horizontally and to automatically pipette reagents onto each slide and remove the reagents by suction. The slides remain in the horizontal position throughout the procedure (i.e. a “flat-bed” approach is used). An example of such an automated machine is the Roche BenchMark ULTRA™ system. However, these automated systems require complicated fluidics systems.

The inventors have sought to overcome the problems associated with existing slide preparation devices.

### SUMMARY OF THE INVENTION

According to a first aspect of the invention, there is provided a coverplate assembly for a microscope slide. The coverplate assembly comprises a coverplate body, at least two flanges arranged on a surface of the coverplate body, and a magnet or magnetic material configured to cooperate with a magnetic counterpart to affix the coverplate to a microscope slide, thereby providing a capillary gap between the coverplate body and the microscope slide.

The coverplate assembly may for example be affixed to the microscope slide by a magnet interacting magnetically with a metal plate on which the microscope slide is positioned and compressing the coverplate and the slide between the magnet and metal.

Advantageously, when the coverplate is affixed to the microscope slide through magnetism, the coverplate provides a capillary gap between the coverplate and the microscope slide. A small volume of treatment liquid can be applied to the microscope slide, and the treatment liquid will pass through the capillary gap by capillary action. When the slide is at an incline, the sequential application of reagents to the slide is achieved by gravity-assisted displacement of the in situ reagent simply by addition of the next reagent. This means that smaller volumes of treatment liquid (such as staining reagents) can be applied to the slide without compromising on quality of the stain. This reduces the costs involved in slide staining protocols, particularly when a precious stain is used. Furthermore, the coverplate can be directly attached over a smaller area of the slide that is intended to be stained, instead of over the entire surface of the slide, permitting a considerable reduction in the surface area of the coverplate and therefore a considerable reduction in the volume of reagent needed to treat that area. This results in significant savings in expensive reagent use compared to other techniques, such as using the Shandon Sequenza apparatus (U.S. Pat. No. 4,985,206).

The coverplate body can be any shape. Typically, the coverplate body is square or rectangular. Typically, the coverplate body is sized to fit on the staining area of a standard microscope slide. A standard microscope slide is typically 75 mm long×25 mm wide.

The coverplate may be made of any material. Typically, the coverplate is made of a rigid material. Typically, the coverplate is made of glass, metal, rigid plastics material or fibreglass. Typically, the coverplate is flat and rigid. In some embodiments, the coverplate body is made of rigid plastics material. In various embodiments, the coverplate body is made of a ferromagnetic material, such as steel. Typically, the coverplate is made from a hydrophilic material, or a material that is relatively hydrophilic compared to the material of the at least two flanges.

The at least two flanges may be formed in any manner that provides a capillary gap between the coverplate body and the microscope slide in use. Typically, the at least two flanges are positioned at the lateral edges of one surface of a coverplate body. Typically, the at least two flanges are positioned on the surface of the coverplate body that opposes the microscope slide in use.

The at least two flanges may be made from any material. In some embodiments, the at least two flanges are lateral strips of a hydrophobic material. In various embodiments, the at least two flanges are made of tape, paint or a powder coating. The flange may be a cured epoxy resin. This latter feature allows some chemical resistance and allows the over plate to be reused after suitable washing.

In some embodiment, the at least two flanges are formed from an adhesive label, such as an adhesive vinyl label. The flanges may themselves be magnetic to allow the coverplate to magnetically attach to the microscope slide. Forming the at least two flanges from a hydrophobic material helps to direct the flow of reagent through the capillary gap and prevents the reagent from spilling over and down the sides of the coverplate.

Alternatively, the flanges may be made by precision milling or etching the coverplate to create a channel and the flanges.

Typically, the at least two flanges are parallel.

The at least two flanges may be 10-80 μm in height from the surface of the coverplate body to provide the appropriate capillary gap. In some embodiments, the at least two flanges are 20-70 μm, 30-60 μm, or 40-50 μm in height. In particular embodiments, the at least two flanges are 70 μm in height.

In some embodiments, the surface of the coverplate body that does not oppose the microscope slide in use (i.e., the upper surface) comprises a hydrophobic material. For example, the surface may be coated with a hydrophobic material. This prevents the reagent liquid spilling over the top of the coverplate and down the upper surface.

The capillary gap defines a volume between the coverplate and the microscope slide when in use. The volume may be any suitable volume for slide staining. In some embodiments, the volume is 5-200 μl. In other embodiments, the volume is 10-150 μl. In particular embodiments, the volume is 15-125 μl. In various embodiments, the volume is 20-100 μl. In some embodiments, the volume is 25-90 μl. In particular embodiments, the volume is 30-85 Ξl. In various embodiments, the volume is 35-80 μl. In some embodiments, the volume is 40-75 μl. In particular embodiments, the volume is 45-70 μl. In various embodiments, the volume is 50-65 μl. In some embodiments, the volume is 55-60 μl. Typically, the volume is 10-100 μl, more typically the volume is 25-80 μl. In particular embodiments, the volume is 15 μl, 20 μl, 25 μl, 50 μl or 80 μl.

Advantageously, the volume defined by the capillary gap may be significantly smaller compared to volumes of the prior art, such as that in the Shandon Sequenza apparatus, which has a volume of 100 μl only. This means that smaller volumes of reagents are required for staining protocols, significantly reducing reagent costs.

In particular embodiments, the coverplate body comprises a notch between the flanges. For example, the flanges may be positioned at the two lateral edges of the coverplate body and the notch may be located at the upper edge of the coverplate body. The upper edge is the edge of the coverplate body that is positioned uppermost when the slide is at an incline. The notch provides the advantage that there is a ledge for applying treatment liquid to the capillary gap. The ledge receives the treatment fluid and prevents the fluid from spilling away from the capillary gap. The treatment fluid subsequently passes through the capillary gap between the coverplate body and the slide.

The notch may be any size or shape. Typically, the notch is semi-circular or v-shaped.

In some embodiments, the notch is open (i.e., cut-out from the coverplate body), thus extending across the full depth of the coverplate body. In other embodiments, the notch is closed on the uppermost side of the coverplate body (i.e., the notch does not extend across the full depth of the coverplate body). This provides the advantage that when the coverplate assembly is assembled on a microscope slide, the closed notch forms a liquid-receiving volume. Reagent may be dispensed into the liquid-receiving volume, which will pass through the gap by capillary action. The closed notch may be machined into the material of the coverplate body or may be closed by a separate flat sheet of material attached to the uppermost surface of the coverplate body. For example, a cover may be attached to the uppermost surface of the coverplate body. The cover may be made of any material. Preferably, the cover is made from a transparent material such as glass or plastics. This provides the advantage that the liquid pipetted into the liquid-receiving volume can be observed, thus visually confirming that capillary action is occurring.

In some embodiments, the magnet or magnetic material is integral to the coverplate body. For example, the coverplate body may comprise a magnetic material, such that the coverplate body interacts magnetically with a magnetic counterpart (e.g., an elongate bar magnet) to affix the coverplate body to the microscope slide. This provides the advantage that an additional magnet is not required to be applied on the uppermost surface of coverplate body to affix the coverplate. In some embodiments, the coverplate body comprises a ferromagnetic material. In some embodiments, the coverplate body comprises steel or is formed from steel. In this case, the steel coverplate body interacts magnetically with a magnetic counterpart (e.g., an elongate bar magnet); a microscope slide may be sandwiched between the magnet and the coverplate body, and the magnet magnetizes the coverplate body and acts to affix the coverplate body to the microscope slide and form the capillary gap. When used with a slide staining apparatus having a rotatable member as described herein, the magnet and the magnetic coverplate body may sandwich the rotatable member and the microscope slide (magnet—rotatable member—microscope slide—magnetic coverplate body) to affix the coverplate body to the microscope slide and the microscope slide to the rotatable member. In this embodiment, the magnet may be an elongate bar magnet that is affixed to the rotatable member formed of magnetic material.

In some embodiments, the magnet or magnetic material is not integral to the coverplate body. For example, the magnet may be detachable from the coverplate body. This provides the advantage that a single magnet can be used to manipulate multiple coverplate bodies. In various embodiments, the magnet is a detachable handle used to manipulate the coverplate bodies.

In some embodiments, the coverplate body comprises a magnetic shim that cooperates with the magnet. Typically, the magnetic shim does not function as the magnetic counterpart to affix the coverplate body to the microscope slide, but instead functions in allowing a detachable magnet to attach and detach from the coverplate body. This provides the advantage that the magnet can be used to pick up the coverplate body and move the coverplate body to, for example, the sample-receiving surface of a microscope slide positioned on a magnetic rotatable member for subsequent slide staining. A further advantage is that the magnet is reversibly attached to the coverplate body, such that a single magnet can be used to manipulate a first coverplate body and can subsequently be detached from the first coverplate body and used to manipulate a further coverplate body.

In a second aspect of the invention, there is provided a kit comprising a coverplate according to any of the embodiments described herein and a microscope slide. The microscope slide may be any type of microscope slide suitable for slide staining. In some embodiments, the microscope slide is a standard glass microscope slide.

In various embodiments, the microscope slide comprises a slide body, an aperture within said slide body, and a viewing window. The viewing window seals said aperture to create a well which is configured to receive a sample and/or one or more treatment liquids. The exemplary microscope slide has been previously described in WO 2015/132583 (see for example the passage on page 12, lines 7 to 20), incorporated in its entirety.

According to a third aspect of the invention, there is provided an apparatus for preparing a plurality of microscope slides. The apparatus comprises a frame and a rotatable member connected to, and rotatable relative to, the frame. The rotatable member is rotatable between a first position and a second position about a rotational axis. The rotatable member comprises a slide fastener to affix the plurality of microscope slides to the rotatable member.

“Rotation” and “rotatable” refers to movement of an object about an axis. The axis may lie within or outside of the body of the object. In some embodiments, the rotatable member rotates about a central axis (i.e., spins). In other embodiments, the rotatable member rotates about an off-centre axis (i.e., tilts).

Advantageously, the inventors have found that by rotating the rotatable member between the first position and the second position, the plurality of microscope slides can be quickly and easily moved between a first position that is suitable for applying various treatment liquids (e.g. staining reagents, blocking reagents etc.) and a second position for effecting removal of said treatment liquids. This greatly improves the efficiency of the process for preparing a plurality of microscope slides for subsequent microscopic examination or analysis compared with conventional systems e.g., those that employ metered deposition and/or directed aspiration of treatment liquid. Furthermore, the slides do not need to be fully immersed in a slide treatment liquid, avoiding wasting precious reagents. The slide fastener functions in attaching the plurality of microscope slides to the rotatable member, such that when the rotatable member rotates, the slides remain affixed to the rotatable member and the treatment liquids can drain from the slides.

The fastener may be any fastener known in the art that is suitable for affixing the plurality of microscope slides to the rotatable member. For example, the fastener may be selected from a clamp, a magnet, suction, Velcro, a groove or slot and the like.

Preferably, the slide fastener comprises a magnet. In some embodiments, the fastener is magnet or comprises a magnetic material. For example, the slide fastener may be a magnetized rotatable member (such as a magnet attached to a rotatable member formed from a magnetic material such as steel). This provides the advantage that the plurality of microscope slides can be reversibly affixed to the rotatable member when the plurality of microscope slides comprise a magnet or are formed or partially formed from a magnetic material such as steel. In some embodiments, the plurality of microscope slides may be reversibly affixed to the rotatable member by being sandwiched between the magnetic slide fastener and a magnetic counterpart. The magnetic counterpart may be the coverplate magnet according to the embodiments described above. The magnetic counterpart may be a magnetic coverplate body (e.g., made from steel).

The rotatable member may be made from a magnetic material and the slide fastener may be integral thereto. For example, the rotatable member may be formed at least partially from a magnetic material such as steel. A magnet may be attached to the rotatable member, for example on the underside of the rotatable member, to magnetize the magnetic material. This provides the advantage that the plurality of microscope slides can be affixed directly to the rotatable member, either by the slides being magnetic or by being sandwiched with the rotatable member and a magnetic counterpart.

The apparatus may further comprise at least one magnetic counterpart for the slide fastener, wherein, in use, the plurality of microscope slides are positioned between the slide fastener and the at least one magnetic counterpart. This provides the advantage that the slides do not need to be magnetic to affix to the magnetic slide fastener. For example, a glass microscope slide may be affixed to the magnetic slide fastener by being sandwiched between the magnetic slide fastener and the magnetic counterpart. In this case, displacement of the magnetic counterpart will detach the slide from the slide fastener.

Typically, the rotatable member is connected to the frame magnetically. The rotatable member may be supported in the first position by a magnetic connection to the frame. This provides the advantage that the rotatable member can be held in the slide staining position by connecting the rotatable member magnetically to the frame. The rotatable member may then be rotated to the second position, breaking the magnetic connection with the frame.

The rotatable member may be made from a magnetic material, or the frame may be made from a magnetic material, or both the rotatable member and the frame may be made from a magnetic material. Typically, the rotatable member is made from a magnetic material (e.g., steel) and the frame is made from a non-magnetic material. The magnetic rotatable member may be connected to the non-magnetic frame using a magnetic counterpart. For example, the frame may be sandwiched between the magnetic rotatable member and the magnetic counterpart in order to connect the rotatable member to the frame (e.g., the magnetic counterpart may be located on an outside wall of the frame and the rotatable member may connect to an inside wall of the frame on the opposite side to the magnetic counterpart).

The rotatable member may be any shape that is suitable for mounting a plurality of microscope slides thereto. For example, the rotatable member may be substantially cylindrical or cuboidal. In another example, the rotatable member may be a substantially flat plate that has been bent out of a single plane. The cross section of the rotatable member may be substantially in the shape of a triangle, circle, oval, square, rectangle, diamond, pentagon, hexagon, X-shape, U-shape, L-shape, or C-shape. Typically, the rotatable member is a substantially flat plate that has been bent out of a single plane, preferably into substantially a U-shape. Preferably, the rotatable member comprises a platform configured to support the plurality of microscope slides. Typically, the platform is substantially flat. This provides the advantage that the plurality of microscope slides are supported on a flat surface, such that the coverplates described herein can be affixed to the plurality of microscope slides. Typically, the rotatable member comprises a flat magnetic plate for supporting the plurality of microscope slides.

In various embodiments, the platform comprises a detachable section, such that when the section is attached, the slides are supported along their length by the platform, whereas when the section is detached, the slides overhang the platform. The slide fastener is typically located in the portion of the platform that is not detachable. Advantageously, the platform is suitable for multiple types of staining:
(a) When the section is detached, the slides are only partially supported by the platform (e.g., at the non-staining end of the slides), and the staining ends of the slides overhang the platform. The slides are affixed to the rotatable member at the non-staining end of the slides. This is suitable for non-precious staining as treatment liquids can be applied to the slides and removed by rotation of the rotatable member. The treatment liquids drain from the slides effectively because the staining ends of the slides are not contacting the platform.
(b) When the detachable section is attached, the slides are supported along their full length by the platform. The slides may be affixed to the rotatable member at the non-staining end of the slides, or may be affixed to the rotatable member at the staining end of the slides, or may be affixed to the rotatable member at the non-staining and staining ends of the slides. This configuration is suitable for precious staining as a coverplate described herein can be affixed to each slide. For example, the slide and coverplate may be sandwiched between a magnetic detachable section below and a magnet above.

In particular embodiments, the rotatable member has a first elongate edge in contact with the frame, wherein the rotational axis of the rotatable member is along said elongate edge. This provides the advantage that the rotatable member tilts about the first elongate edge to provide the rotational motion of the apparatus.

In some embodiments, the rotatable member has a second elongate edge that does not contact the frame in the first position and contacts the frame in the second position. For example, the second elongate edge may define one edge of the platform. When the rotatable member is rotated (e.g., tilted), the second elongate edge may contact the frame at the second position, preventing further rotation of the rotatable member. This provides the advantage that rotation of the rotatable member is restricted to rotation between the first position and the second position.

In particular embodiments, the frame is a container and the rotatable member is positioned inside the container. This provides the advantage that the frame functions in supporting the rotation of the rotatable member and collecting treatment liquids that have been applied to the plurality of microscope slides and have drained off the slides following rotation of the slides, via rotation of the rotatable member. The container may comprise a detachable bung, to facilitate removal of drained treatment liquids from the frame.

The frame may be a supporting structure for the rotatable member. In some embodiments, the frame is a member which contacts the rotatable member at a first end and a second end of the rotatable member. In some embodiments, the rotatable member comprises a shaft which contacts the frame at a first end and a second end of the shaft.

In some embodiments, the frame supports a single rotatable member and in other embodiments, the frame supports a plurality of rotatable members. For example, the frame may support a plurality of rotatable members, each rotatable member suitable for mounting a plurality of microscope slides. The frame may support further members, including but not limited to one or more fluid containment/collection trays, one or more fluid distributing devices, and/or one or more fluid reservoirs (for example containing the one or more treatment liquids or sealant).

In various embodiments, the frame may be placed into a temperature- and/or humidity-controlled unit, such as an oven, an incubator or a refrigerator. In other embodiments, the frame is an integral component of the temperature- and/or humidity-controlled unit.

In some embodiments, the rotatable member is disconnectable from the frame. This provides the advantage that the rotatable member can be removed from the frame to provide easier access for mounting and dismounting the plurality of microscope slides from the rotatable member.

The rotatable member may be connected to a rotation actuator, whereby actuation of the rotation actuator causes rotation of the rotatable member about the rotational axis. In some embodiments, the rotation actuator is a handle shaft. This provides the advantage that the rotatable member can be rotated easily by the user. In some embodiments, apparatus comprises one or more handles. The one or more handles may be integral to the rotatable member, or detachable from the rotatable member. In some embodiments, the one of more handles are magnetic, such that the one or more handles can be reversibly affixed to the rotatable member (e.g., via the magnetic slide fastener and/or the magnetic rotatable member). This provides the advantage that the handle can be affixed to the rotatable member and can be used to actuate rotation of the rotatable member with weak force, and can be detached from the rotatable member through stronger force. Typically, the one or more handles are the magnetic counterparts for the magnetic slide fastener.

In certain embodiments where the rotatable member is connected to, and rotatable relative to, a frame, the handle shaft may be positioned external to the frame. In particular embodiments, the rotation actuator is a motor.

In some embodiments, the rotatable member is an elongate bar and the rotational axis is along the longitudinal axis of the elongate bar. In some embodiments, the fastener is along the length of the elongate bar. For example, the fastener may be a single groove or plurality of slots positioned along the length of the elongate bar (i.e. parallel to the rotational axis of the elongate bar). It may be the case that the elongate bar comprises a plurality of fasteners positioned along the length of the elongate bar. For instance, in some embodiments, the elongate bar may comprise a first groove or plurality of slots positioned in a first surface along the length of the elongate bar, and a second groove or plurality of slots positioned in a second surface along the length of the elongate bar, optionally wherein the first and second grooves or pluralities of slots are parallel to one another and to the rotational axis of the elongate bar.

In other embodiments, the fastener comprises one or more grooves or slots. The fastener may comprise a single groove that is configured to receive a plurality of microscope slides. Alternatively, the fastener may comprise a plurality of slots, each slot configured to receive a single microscope slide. The groove or plurality of slots may be configured to receive an end of each microscope slide. The groove or plurality of slots may comprise an internally extending flange. This provides the advantage that the plurality of microscope slides can be reversibly affixed to the rotatable member by placing an end of each slide into the groove or slot. The rotatable member can be rotated between the first position and the second position and the plurality of slides will remain affixed to the rotatable member. The plurality of slides can be removed from the rotatable member by lifting the slides out of the groove or slot. Alternatively, the rotatable member can be positioned by the user such that the slides are contacted on their undersides by a slide-receiving surface (e.g. a table), and the rotatable member is moved in a direction that causes the slides to drop out of the groove or slots onto the slide-receiving surface.

In some embodiments, the fastener comprises at least one slide mounting guide. The at least one slide mounting guide may be one or more ridges that guide placement of an individual microscope slide between the ridges. In particular embodiments, the fastener comprise one or more slots, wherein each slot guides the placement of an individual microscope slide within the slot. Slide mounting guides provide the advantage that each slide will be in the correct position when mounted on the rotatable member, such that liquids dispensed by the dispenser will be correctly dispensed onto the slides.

In certain embodiments, the rotatable member is operably connected to a locking mechanism to prevent rotation of the rotatable member. Any suitable locking mechanism known in the art may be used. Preferably, the locking mechanism prevents rotation of the rotatable member using friction. The locking mechanism may be connected to the frame. In some embodiments, the locking mechanism is a fixture, such as a bolt. For example, the fixture may affix the rotatable member to the frame in a first configuration, thereby preventing rotation of the rotatable member, and not affix the rotatable member in a second configuration, thereby not impeding rotation of the rotatable member.

Typically, the rotation of the rotatable member is restricted by the shape of the frame, such that the rotatable member is in contact with the frame in the first position, the rotatable member can freely rotate between the first and second position, and the rotatable member is in contact with the frame in the second position. In other embodiments, the rotatable member may be capable of rotating 360° about the rotation axis. It is often the case that rotation of the rotatable member is restricted such that the rotatable member can only rotate between the first position and the second position.

In particular embodiments, the rotatable member is operably connected to a rotation guide configured to restrict rotation of the rotatable member about the rotational axis. Any suitable rotation guide known in the art may be used. In some embodiments, the rotatable member comprises an extension portion which contacts the frame when the rotatable member is in the first position and/or the second position. For example, the rotation guide may be an L-shaped plate that is connected to the rotatable member at a first end, extending radially outwards from the axis of rotation. In various embodiments, the frame may comprise an extension portion which contacts the rotatable member when the rotatable member is in the first position and/or the second position. In other embodiments, the frame comprises an extension portion which contacts the plurality of microscope slides when the rotatable member is in the first position and/or the second position. In particular embodiments, the rotatable member comprises a shaft and the frame comprises a rotation guide which restricts the rotation of the shaft, optionally between the first position and the second position.

In some embodiments, the rotatable member further comprises one or more conduits for the removal of the one or more treatment liquids. The rotatable member may be an elongate bar and the one or more conduits may be positioned along the longitudinal length of the elongate bar. For example, the rotatable member may comprise one or more grooves or pluralities of slots that function as a fastener and as a fluid conduit. In some embodiments, the one or more conduits are inclined such that when the rotatable member is level (e.g. substantially horizontal), fluid within the one or more conduits is drained from the one or more conduits by gravity. For example, when the rotatable member is rotated to the second position, treatment liquid from the plurality of slides may drain into the one or more fluid conduits by gravity and drain from the rotatable member by gravity. The one or more fluid conduits may be connected to a fluid container, such as a containment tray or a waste bottle, such that fluids from the one or more fluid conduits drain into the fluid container.

In various embodiments, the apparatus further comprises a lid, a collection vessel (e.g. a tray or bottle), a heating element, a cooling element, a liquid dispenser, a microscope, or a combination thereof.

In some embodiments, the lid comprises one or more magnets which connect the rotatable member to the frame. For example, the lid may be removed from the frame and positioned on the exterior of the frame to cooperate with the rotatable member, sandwiching the frame between the one or more magnets of the lid and the rotatable member.

The apparatus may further comprise a plurality of microscope slides. The microscope slides may be any type of microscope slides, such as standard glass microscope slides.

In some embodiments, the plurality of microscope slides each comprise a slide body, an aperture within said slide body, and a viewing window. The viewing window seals said aperture to create a well which is configured to receive a sample and/or one or more treatment liquids.

One of the advantages associated with slides of this design is that there is a reduction in chromatic dispersion compared to conventional microscope slides. In conventional microscope slides, light passes through the typically 1 mm thick glass base before interacting with the sample and subsequently travelling into the microscope. Light passing through this thick base layer of glass is chromatically dispersed and this reduces the quality of the image. In contrast, in the slides of this design, a very thin layer (typically less than 100 μm) of sealant replaces this 1 mm glass layer, reducing the distance light has the travel in the medium before reaching the sample thereby reducing the degree of chromatic dispersion. However, in addition, the presence of an integral window makes these slides especially useful in combination with the apparatus described herein as the well improves retention of fluid on the slide when the slide is in the first position. Accordingly, if the slide is not perfectly horizontal when in the first position, fluid still is retained in an adequate fashion. Moreover, the deposition of fluid onto the sample can be more easily controlled than with a conventional microscope slide, where fluid deposited on a uniformly flat glass surface is liable to flood over the slide and runoff.

The body of the plurality of microscope slides may be made of an optically transparent material, an optically partially transparent material or an optically non-transparent material. Accordingly, the body of the plurality of microscope slides may be made of, for example, glass, plastics or metal. The material may be a thermoset resin. Optically transparent thermoset resins are generally known in the art.

Typically, the body of the plurality of microscope slides is made of metal. There is no particular restriction on the type of metal from which the body of the plurality of microscope slides is made. The metal may be an alloy or pure metal and is typically selected from steel, brass, aluminium or combinations thereof, most typically, the metal is aluminium. In some embodiments, the body of the plurality of microscope slides may be magnetic or ferromagnetic. This allows the slides to be attached to magnetic or ferromagnetic surfaces. In some embodiments, the body of the plurality of microscope slides and the fastener are magnetic or ferromagnetic, allowing the slides to be affixed to the rotatable member by magnetism.

Typically, the viewing window of the plurality of microscope slides is optically transparent and made of glass or plastic. Optically transparent thermoset resins are generally known in the art.

Typically, the plurality of microscope slides are those as described in WO 2015/132583 A1, which is incorporated by reference herein in its entirety.

The apparatus may further comprise at least one dispenser configured to deliver the one or more treatment liquids to the plurality of microscope slides. Advantageously, a volume of a treatment liquid can be provided to the at least one dispenser which is dispensed onto the plurality of microscope slides. This avoids having to dispense treatment liquid individually onto each of the slides, making the process quicker and more efficient. The at least one dispenser is typically an enclosed fluid conduit, and is preferably hollow and substantially cylindrical. The at least one dispenser may function as a container for treatment liquid in a first configuration and a dispenser for treatment liquid in a second configuration. The at least one dispenser may be connected to the frame. The at least one dispenser may be connected to, and rotatable relative to, the frame. The at least one dispenser may be moveable relative to the rotatable member. Typically, the at least one dispenser is moveable along the longitudinal length of the rotatable member. In some embodiments, the at least one dispenser is moveable along the longitudinal length and the lateral width of the rotatable member. Movement of the at least one dispenser relative to the rotatable member provides the advantage that the at least one dispenser (more particularly, the dispensing apertures) may be aligned with the plurality of microscope slides.

In some embodiments, the apparatus comprises a plurality of dispensers configured to deliver the one or more treatment liquids to the plurality of microscope slides. Each dispenser may comprise one or more dispensing apertures. In various embodiments, each dispenser comprises a single dispensing aperture. Advantageously, a volume of a treatment liquid can be provided to each dispenser which is dispensed through the dispensing aperture onto the microscope slide. In particular embodiments, each dispenser may be selected from a pipette, a burette, an optic dispenser or a volumetric fluid dispenser.

Typically, the apparatus comprises at least one dispenser that comprises a plurality of dispensing apertures. Advantageously, a volume of a treatment liquid can be provided to the at least one dispenser which is distributed substantially evenly through the plurality of dispensing apertures onto the plurality of microscope slides. In one example, if there are ten slides receiving 1 ml of treatment liquid each, 10 ml of treatment liquid can be supplied to the dispenser which will then evenly distribute 1 ml of treatment liquid to each slide.

The dispensing apertures may be gated such that fluid cannot flow through the dispensing apertures in a first configuration and fluid can flow through the dispensing apertures in the second configuration. This may be a simple open and closed gating system. This provides the advantage that the user can dispense liquid at specified times by switching the at least one dispenser from the first configuration to the second configuration. In particular embodiments, the dispensing apertures are independently gated. This provides the advantage that the user can select which dispensing apertures to use, depending on the number of microscope slides being stained (e.g. if there are 20 apertures and 6 slides being prepared, 14 apertures can be gated shut such that they do not dispense fluid). The dispensing apertures may be gated using any means known in the art, such as using at least one valve.

Typically, the at least one dispenser is rotatable between a first position and a second position about a rotational axis which provides a gating mechanism for the dispensing apertures. When the at least one dispenser is in the first position, the dispensing apertures may be positioned such that fluid cannot flow through the dispensing apertures. When the at least one dispenser is in the second position, the dispensing apertures may be positioned such that fluid can flow through the dispensing apertures. This provides the advantage that the user can dispense liquid at specified times by rotating the at least one dispenser from the first position to the second position. For example, the at least one dispenser may be a hollow cylinder with one or more dispensing apertures positioned along its longitudinal length. In a first position, the dispensing apertures may be positioned at an angle of rotation such that fluid is contained within the dispenser (e.g. the dispensing apertures may be positioned on or above the horizontal axis of the dispenser). In a second position, the dispensing apertures may be positioned at an angle of rotation such that fluid is dispensed through the dispensing apertures (e.g. the dispensing apertures may be positioned on the vertical axis of the dispenser facing towards the plurality of slides). This provides the advantage that fluid is dispensed by gravity when the dispenser is in the second position.

The dispensing apertures may be spaced apart such that, in use, the dispensing apertures align with the plurality of microscope slides. For example, if the rotatable member is capable of mounting ten slides, the dispenser may comprise ten dispensing apertures that are positioned directly over the ten mounted microscope slides. Alternatively, ten dispensers may be provided, each comprising a single dispensing aperture that is positioned over a microscope slide.

In some embodiments, the dispenser or plurality of dispensers is supplied from at least one reservoir. The at least one reservoir may be a fluid container, which may comprise one or more valves to control release of a treatment liquid. The at least one reservoir may be connected to the frame. The at least one reservoir may be connected to, and rotatable relative to, the frame.

Typically, the dispenser or plurality of dispensers is supplied from a plurality of reservoirs, wherein the number of reservoirs corresponds to the number of treatment liquids required for a given staining protocol. As one skilled in the art would appreciate, the number of reservoirs may be selected/altered to allow multiple staining protocols to be implemented. The reservoirs may each contain one or more washing reagents (such as a buffer or water), one or more alcohols (such as ethanol), one or more staining reagents or one or more dewaxing/clearing reagents (such as xylene), wherein each reagent is contained within a different reservoir.

In a fourth aspect of the invention, there is provided a kit comprising a coverplate according to any of the embodiments described herein and an apparatus according to the any of the embodiments described herein.

Typically, the coverplate described herein is suitable and designed to be used with the apparatus described herein. For example, the slide fastener of the rotatable member of the apparatus may be magnetic, functioning as the magnetic counterpart for the coverplate magnet. This provides the advantage that a microscope slide can be positioned between the coverplate magnet and the magnetic rotatable member, affixing the coverplate to the microscope slide and the microscope slide to the rotatable member. The order of components is: magnetic rotatable member—microscope slide—coverplate body—coverplate magnet. The magnetic interaction of the rotatable member and the coverplate magnet secures the coverplate body to the microscope slide. This has two functions:
1) a capillary gap is formed between the slide and the coverplate body; treatment liquid can be applied to the top of the capillary gap and will exit at the bottom of the capillary gap, through gravity and surface tension;
2) the slides are fastened to the rotatable member such that when the rotatable member is rotated (e.g., tilted), the slides remain fastened to the rotatable member; treatment liquid can flow through the capillary gap.

In a fifth aspect of the invention, there is provided a method of preparing a plurality of microscope slides. The method comprises the steps of:
(a) optionally applying one or more samples to the plurality of microscope slides;
(b) mounting the plurality of microscope slides on a rotatable member, the rotatable member being rotatable between a first position and a second position about a rotational axis;
(c) applying one or more treatment liquids to the plurality of microscope slides in the first position; and
(d) rotating the rotatable member to a second position to effect removal of the one or more treatment liquids;
(e) optionally drying the plurality of microscope slides;
(f) optionally repeating steps one or more of steps (c) to (e);
(g) optionally applying sealant to the plurality of microscope slides;
(h) optionally removing the plurality of microscope slides from the rotatable member;
wherein the rotatable member comprises a fastener to affix the plurality of microscope slides to the rotatable member.

Advantageously, the inventors have found that by rotating the rotatable member between the first position and the second position, the plurality of microscope slides can be quickly and easily moved between a first position that is suitable for applying various treatment liquids (e.g. staining reagents, blocking reagents etc.) and a second position for effecting removal of said treatment liquids. This greatly improves the efficiency of the process for preparing a plurality of microscope slides for subsequent microscopic examination or analysis compared with conventional systems e.g. those that employ metered deposition and/or directed aspiration of treatment liquid. Furthermore, the slides do not need to be fully immersed in a slide treatment liquid, avoiding wasting precious reagents.

The method may include a step of applying one or more samples to the plurality of microscope slides. Typically, a sample is applied to the sample-receiving surface of the plurality of microscope slides. Preferably, a sample is applied to a well comprising a viewing window that is positioned within the body of a microscope slide. The sample may be applied to the slide using any method known in the art, for example by wet mounting, dry mounting, smearing, squashing or floating out. For example, the sample may be a tissue section that was mounted in wax and cut using a microtome, and subsequently floated on a water bath from where the section is placed on the microscope slide.

The sample may be any sample for which microscopic analysis is desired. Typically, the sample is a histological or cytological sample. Often, the sample is biological, e.g. animal or plant tissue and may be a medical or veterinarian biopsy or resection tissue sample.

The sample may be a tissue section (i.e. “slice”) cut on a microtome, for example, a fresh tissue section or a tissue section embedded in, for example, paraffin wax. The sample may be a frozen tissue section (i.e. cryosection) embedded in, for example, optimal cutting temperature (OCT) compound. A tissue section is typically between 2 and 7 μm thick. The sample may be a cytological smear, such as a smear from a cervical examination or a blood smear. The sample may be a cytospin cytological sample. Cytospin samples are typically taken from, for example, sputum or by a fine needle aspirate, and cells spun down by a centrifuge onto a microscope slide. The sample may be in vitro tissue cultured cells, and in some embodiments, the cells were cultured directly on the microscope slide or a coverslip.

The rotatable member may be any member that is capable of rotating about a rotation axis. The “first position” is the position of the rotatable member at a first angle of rotation about the rotation axis, and the “second position” is the position of the rotatable member at a second angle of rotation about the rotation axis. Typically, the first and second positions are not at the same angle of rotation about the rotation axis. The first and/or second positions may be pre-defined (i.e. the user has no control over the position of the first and/or second positions), or undefined (i.e. the user has total or partial control over the position of the first and/or second positions).

It is often the case that the plurality of slides mounted on the rotatable member in the first position are substantially horizontal (i.e. the sample-receiving surface of the slide is level and in a horizontal plane). This provides the advantage that the one or more treatment liquids applied to the slides in the first position are retained on the slides. In preferable embodiments, the plurality of slides each comprise a well with a viewing window, and the one or more treatment liquids are applied directly to the wells. This provides the advantage that the one or more treatment liquids are contained within the wells when the rotatable member is in the first position, and thus the rotatable member in the first position does not need to be precisely level. However, it is also envisaged that when conventional microscope slides are used, a limited volume (i.e. a bubble) of the one or more treatment liquids would be retained on the surface of slides when the rotatable member is in the first position, up to the maximum surface tension of the liquid.

It is often the case that the plurality of slides mounted on the rotatable member in the second position are not substantially horizontal (i.e. the sample-receiving surface of the slide is not level and is inclined with respect to the horizontal plane). This provides the advantage that any liquid present on the slides is removed (i.e. drained) from the slides. Typically, the slides are inclined in the second position such that the end of the slide not affixed to the fastener (i.e. the distal end of the slide) is located closer to the ground compared to the end of the slide affixed to the fastener (i.e. the proximal end of the slide). This provides the advantage that liquid run-off is directed away from the rotatable member which prevents contamination of the rotatable member and the slides during repeated rotation between the first and second positions. However, embodiments are also envisaged where the distal end of the slide is located further from the ground compared to the proximal end of the slide, such that liquid run-off is directed towards the rotatable member. In this case, the rotatable member may comprise one or more fluid conduits for draining liquid run-off from the rotatable member.

The one or more treatment liquids may be any liquid suitable for use in a histological or cytological preparation method. Often, the one or more treatment liquids may be selected from dewaxing reagents, enzyme substrate reagents, hydrating reagents, water, blocking reagents, washing reagents, staining reagents, fixing reagents, blueing reagents, differentiating/destaining agents, dehydrating reagents, clearing reagents, permeabilisation reagents, antigen retrieval reagents, or any combination thereof.

Dewaxing reagents and clearing reagents may include solvents such as xylene, xylene substitutes (e.g. toluene) and alcohols. An example of an enzyme substrate is Naphthol AS-BI-phosphate disodium salt as the substrate for the histochemical detection of acid phosphatase and alkaline phosphatase. Hydrating and dehydrating reagents typically include alcohols, such as ethanol and isopropyl alcohol. As is known in the art, slides may be exposed to several changes of alcohol of increasing or decreasing concentration. Blocking reagents may include serum (e.g. from goat, donkey, rabbit, mouse, horse, hamster, sheep, rat, chicken, bovine calf, monkey, guinea pig, llama, dog), bovine serum albumin, casein, gelatin, milk, protein-blocking buffers, enzyme blocking reagents (such as hydrogen peroxidase in methanol). Washing reagents may include water and buffers, for example phosphate-buffered saline (PBS), PBS-Tween20, Tris-buffered saline (TBS), TBS-Tween20, Tris-HCl, Tris-HC-Tween20, Phosphate buffer, AP buffer.

Staining reagents may include non-specific stains and/or marker-specific stains. For example, a staining reagent may be selected from haematoxylin, eosin, Giemsa, orange G, fuchsin, methylene blue, Wright's stain, periodic acid-Schiff, alcian blue, van Gieson, lactophenol cotton blue, Leishman's stain, Kovac's reagent, acridine orange, crystal violet, Bismarck brown, carmine, Coomassie blue, DAPI, ethidium bromine, Hoechst, iodine, malachite green, neutral/toluene red, Nile blue, Nile red, osmium tetroxide, rhodaine, safranin, unconjugated primary antibodies, conjugated primary antibodies (e.g. to fluorescent labels), unconjugated secondary antibodies, conjugated secondary antibodies (e.g. to enzymes, such as HRP or AP, or fluorescent labels), chromogens (e.g. DAB, AEC, BCIP/NBT, Fast Red, Permanent red) or a combination thereof.

Fixing reagents may include, for example, formaldehyde, formalin, formal acetic alcohol, paraformaldehyde, Bouin's solution, Hollande's fixative, acetic fixative, ethanol, methanol, zinc fixative and picric acid. Blueing reagents may include water, Scott's Tap Water, ammonia water. Differentiating reagents may include acid alcohol (e.g. 1% acid alcohol; 70% ethanol that contains 1% HCl). Dehydrating reagents may include, for example, alcohols, such as ethanol and isopropyl alcohol. Clearing reagents may include, for example, xylene. Antigen retrieval reagents may include proteinase K, trypsin, and pepsin, citrate buffer, EDTA buffer, Tris buffer and Tris-EDTA buffer.

Typically, the one or more treatment liquids are applied to the surface of the plurality of slides on which the sample is present. The application of the one or more treatment liquids may be by any means known in the art, such as dispensing by gravity (e.g. using a burette or a distributing device), dispensing by pressure (e.g. using a pipette or a syringe) or dipping the slides into a reservoir containing the treatment liquid. Preferably, the one or more treatment liquids are dispensed using gravity, and more preferably, the one or more treatment liquids are dispensed using a gravity-led distribution device.

Typically, the one or more treatment liquids are removed from the surface of the plurality of slides on which the sample is present. The removal of the one or more treatment liquids may be by any means known in the art, such as removal by gravity, aspiration of the liquid or directional air flow. Preferably, the one or more treatment liquids are removed by gravity, and more preferably, the one or more treatment liquids are removed by tipping of the slides from a horizontal plane to an inclined plane, such that liquid runs off the surface of the slide by gravity.

The method may include one or more drying steps where the plurality of microscope slides are dried for a period of time. For example, the slides may be dried for 0 h-48 h, 10 s-24 h, 20 s-18 h, 30 s-12 h, 40 s-10 h, 50 s-8 h, 1 min-6 h, 2 min-4 h, 3 min-3 h, 4 min-2 h, 5 min-1 h, 10 min-50 min, 20 min-40 min, or 25 min-30 min.

The one or more drying steps may be performed at any suitable temperature. For example, the one or more drying steps may be performed at 0-200° C., 4-150° C., 10-100° C., 20-90° C., 30-80° C., 40-70° C., or 50-65° C.

The one or more drying steps may be performed at any point in the method. Often, a drying step is performed after the step of applying a sample to the plurality of microscope slides. This provides the advantage of adhering the sample to the surface of the slide, and is typically carried out at 65° C. The one or more drying steps may be performed after the step of rotating the rotatable member to a second position to effect removal of the one or more treatment liquids, and/or after the step of applying sealant to the plurality of microscope slides.

The method may include one or more incubation steps where the plurality of microscope slides are incubated for a period of time. For example, the slides may be incubated for 0 h-48 h, 10 s-24 h, 20 s-18 h, 30 s-12 h, 40 s-10 h, 50 s-8 h, 1 min-6 h, 2 min-4 h, 3 min-3 h, 4 min-2 h, 5 min-1 h, 10 min-50 min, 20 min-40 min, 25 min-30 min, or 30 s-2 min. It may be the case that the slides are incubated for 30 s-1 h.

The one or more incubation steps may be performed at any suitable temperature. For example, the one or more incubation steps may be performed at 0-200° C., 4-150° C., 10-100° C., 20-90° C., 30-80° C., 40-70° C., or 50-65° C. Typically, the one or more incubation steps are performed at 4-40° C. In some embodiments, the one or more incubation steps are performed at 4° C. In some embodiments, the one or more incubation steps are performed at 37° C. In some embodiments, the one or more incubation steps are performed at 95° C.

The one or more incubation steps may be performed at any point in the method. Often, an incubation step is performed after the step of applying one or more treatment liquids to the plurality of slides in the first position. For example, the plurality of slides may be incubated for a period of time after a blocking reagent has been applied to the slides, typically at room temperature. As a further example, the plurality of slides may be incubated for a period of time after a staining reagent has been applied to the slides, typically at 4° C. As a further example, the plurality of slides may be incubated for a period of time after an antigen retrieval reagent has been applied to the slides, typically at 95° C.

The skilled person is aware that many different slide preparation protocols exist that require different steps performed for different lengths of time and in different conditions (i.e. temperature, humidity etc.). It is well within the skilled person's remit to adapt the claimed method accordingly to perform different stains on different samples and achieve the desired result.

The method may include a step of applying sealant to the plurality of microscope slides. Typically, the sealant is applied to the sample on the surface of the microscope slide. Typically, the sealant is applied as a final treatment step (i.e. no further liquids are applied to the slide). Preferably, the method does not include the step of mounting a coverslip onto the slide. Typically, no coverslip mounting fluid is used in any aspects of the invention, although the same solvent and chemical polymers that are used for coverslip mounting may be used as a sealant.

The sealant may be a rapid setting sealant such as a thermoset epoxy resin or a thermoplastic nail varnish-type polymer. As the sample is not necessarily illuminated through the sealant (i.e. the tissue sample may be illuminated through a transparent coverslip/base/attenuated area, or by using reflected light) it is possible to use non-optically transparent sealants. Where the tissue is illuminated through the sealant (as in a standard optical microscope), the sealant will, of necessity, be translucent.

The sealant is typically applied to the slide either as a liquid or by spraying as an aerosol. Preferably, the sealant is applied as a liquid. This allows a thin film of sealant to be applied evenly onto a sample and therefore improves transmission and reduced dispersion of light through the slide so as to yield a better quality image than conventional slides. Typically, the thickness of the film will be less than 250 μm.

There is no particular restriction of the type of sealant used in the invention, however it is preferred that sealant has low viscosity, a similar refractive index to the materials used in the window of the slide (typically glass), dries quickly and is optically clear. Typically, the sealant comprises distyrene plastics or acrylic plastics as these plastics have a refractive index very similar to glass. The sealant typically includes a solvent to facilitate application of the sealant to the slide which can subsequently evaporate leaving behind the other sealant components as a thin film. Other components can also be added to improve the film forming or optical properties of the sealant such as dewetting agents to minimize the formation of a meniscus which can act as a lens, distorting images.

The sealant may be substantially opaque, such as an opaque black colour. This latter type of sealant is of benefit where immunofluorescence standing is used to reduce or eliminate background stray light and to absorb redundant UV stimulatory light. This assists in reducing background and increases contrast of the stained sample. This principle is shown for example in U.S. Pat. No. 5,095,213. Alternatively or additionally the slide may itself be opaque. Black metal slides are generally known for reflective light microscopy

In various embodiments, the method further comprises the step of applying one or more treatment liquids to the plurality of microscope slides in the second position, typically wherein the treatment liquid is a solvent. Typically, the one or more treatment liquids is selected from water, hydrating reagents, dehydrating reagents, washing reagents, blueing reagents, or a combination thereof. As one skilled in the art will appreciate, when the one or more treatment liquids is applied to the plurality of microscope slides in the second position, the one or more treatment liquids will not be retained on the slides and will instead run off the slides. Accordingly, this step is suitable for washing or rinsing the slides continually in a treatment liquid. For example, a washing reagent, such as water, may be applied to the plurality of the microscope slides in the second position for a period of time, said washing reagent contacting the slides and running off the slides. The one or more treatment liquids may be applied continuously to the slides in the second position for 5 s-10 min, 10 s-8 min, 20 s-6 min, 30 s-5 min, 40 s-4 min, 50 s-3 min, or 1 min-2 min.

The method may involve repeating one or more steps of the method at least once, or a plurality of times. Any step in the method may be repeated. The skilled person understands that different staining protocols require different steps repeating. For example, the step of applying one or more treatment liquids to the plurality of microscope slides in the first position may be repeated at least once, or a plurality of times (for example, up to 20 times). The step of rotating the rotatable member to a second position to effect removal of the one or more treatment liquids may be repeated at least once, or a plurality of times (for example, up to 20 times). The step of drying the plurality of microscope slides may be repeated at least once, or a plurality of times (for example, up to 20 times).

In some embodiments, the block of steps comprising applying one or more treatment liquids to the plurality of microscope slides in the first position and rotating the rotatable member to a second position to effect removal of the one or more treatment liquids may be repeated at least once, or a plurality of times (for example, up to 20 times). In various embodiments, the block of steps comprising applying one or more treatment liquids to the plurality of microscope slides in the first position, rotating the rotatable member to a second position to effect removal of the one or more treatment liquids, and drying the plurality of slides may be repeated at least once, or a plurality of times (for example, up to 20 times). It is envisaged that additional steps can be included in these blocks of repetitive method steps. A key advantage of the claimed invention is that a plurality of slides can be moved between the first and second positions to make preparation and/or staining protocols more efficient. Protocols with repetitive steps (e.g. application of multiple treatment liquids and/or multiple washing steps) can be arduous when working with large numbers of slides and therefore it is of major benefit to rotate a plurality of slides with a single movement of the rotatable member between a staining position and a washing position, reducing the time spent on each individual step of the protocol.

The method may include a step of removing the plurality of microscope slides from the rotatable member. The slides may be removed individually (i.e. one after another) or all at once. This step may occur after the final treatment liquid has been removed from the slides, or after a drying step, or after a sealant application step, or after the rotatable member has been disconnected from the frame. Typically, this removal step occurs as a final step of the method.

The method may be performed in illuminated or non-illuminated conditions. The method may be performed entirely or partially in the dark. The method may be performed entirely or partially under a light. The method may be performed entirely or partially under a safelight. In various embodiments, the methods may be performed entirely or partially under a UV light.

In some embodiments, the method further comprises detaching a section of the rotatable member such that the method is suitable for non-precious staining; and/or attaching a section of the rotatable member such that the method is suitable for precious staining.

In various embodiments, the method further comprises affixing a coverplate according to any of the embodiments described herein to one of the plurality of microscope slides. In some embodiments, the method further comprises affixing a coverplate according to any of the embodiments described herein to each of the plurality of microscope slides. Typically, affixing a coverplate to a microscope slide involves placing the coverplate body onto the sample-receiving surface of the microscope slide, and applying the coverplate magnet to the surface of the coverplate body such that a capillary gap is formed (i.e., the flanges are in contact with the microscope slide). For example, placing the magnet on to the surface of the coverplate body will affix the coverplate body to the microscope slide, when the microscope slide is positioned on a magnetic slide fastener (e.g., when the rotatable member is magnetic).

The invention has been described in greater detail for some aspects and embodiments compared to other aspects and embodiments. However, it will be appreciated that the description relating to individual aspects and embodiments is equally applicable to the description relating to the other aspects and embodiments. For example, the description relating to the coverplate assembly and the apparatus is equally relevant and applicable to the kits and the methods, and vice versa.

### BRIEF DESCRIPTION OF THE DRAWINGS

The invention will now be described in detail by way of example only with reference to the figures in which:

FIG. 1 shows views of an exemplary embodiment of the coverplate assembly, without the magnet shown. (A) Top view; (B) side view; (C) top perspective view; (D) bottom view; (E) bottom perspective view.

FIG. 2 shows a top perspective view of an exemplary embodiment of the coverplate assembly, illustrating the coverplate body assembled with the magnet.

FIG. 3 shows views of an exemplary embodiment of the coverplate assembly assembled with a microscope slide. (A) Top view; (B) top perspective view.

FIG. 4 shows perspective views of an exemplary embodiment of the coverplate assembly assembled with a microscope slide and the rotatable member of an exemplary slide staining apparatus.

FIG. 5 illustrates the operation of the assembly of FIGS. 3 and 4, where sequential application of reagents to the slide is achieved by gravity-assisted displacement of the in situ reagent by addition of the next reagent.

FIG. 6 shows staining that has been achieved using the exemplary coverplate of the invention.

FIG. 7 shows an exemplary embodiment of the slide staining apparatus. (A) and (B) show perspective views of an exemplary embodiment of the rotatable member, where the rotatable member is a platform. (C) and (D) show the rotatable member mounted on a frame, the frame being a container. In (C), the rotatable member is in the slide staining position. In (D), the rotatable member is in the slide draining position,

FIG. 8 shows an exemplary embodiment of a rotatable member which has a detachable section, such that the apparatus can be converted from a standard staining apparatus to a precious staining apparatus and vice versa. (A-C) shows perspective views of the rotatable member with the detachable section removed. (D) shows the rotatable member (with the detachable section removed) mounted on the frame with a plurality of microscope slides affixed to the rotatable member. (E) shows a perspective view of the rotatable member with the detachable section attached. (F) shows the detachable member being removed from the rotatable member

FIG. 9 shows an exemplary embodiment of the rotatable member. (A) front view; (B) end view.

FIG. 10 shows a perspective view of an exemplary embodiment of the rotatable member.

FIG. 11 shows a perspective view of an exemplary embodiment of the frame.

FIG. 12 shows a front view of an exemplary embodiment of the rotatable member connected to the frame.

FIG. 13 shows a perspective view of an exemplary embodiment of the rotatable member connected to the frame.

FIG. 14 shows a perspective view of an exemplary embodiment of the apparatus with slides mounted on the rotatable member in the slide staining position.

FIG. 15 shows a perspective view of an exemplary embodiment of the apparatus with slides mounted on the rotatable member in the slide draining position.

FIG. 16 shows an exemplary microscope slide to be used with the apparatus and method. (A) Top view; (B) perspective view.

### DETAILED DESCRIPTION OF THE INVENTION

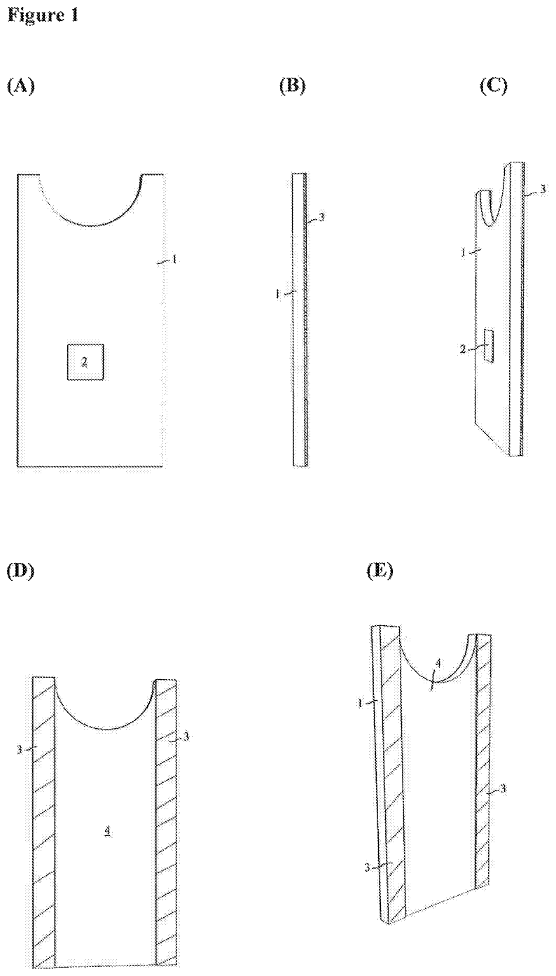

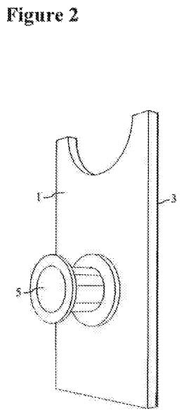

FIG. 1(A-E) shows an exemplary embodiment of the coverplate body 1 (without the magnet). The coverplate body 1 is a thin, flat and rigid plate of glass that is generally rectangular with a U-shaped notch in one of the shorter length sides. The radius of the notch is typically 10-25 mm, more typically about 19 mm. This side corresponds to the upper edge of the coverplate body 1 (i.e., positioned uppermost in use). The dimensions of the coverplate body 1 are typically 25 mm

The coverplate body 1 has a first surface (lowermost surface) that faces the microscope slide in use, and a second surface (uppermost surface). The coverplate body 1 has a magnetic shim 2 made from steel that is attached to the uppermost surface of the coverplate body 1 by adhesive.

Two parallel flanges 3 are positioned on the lowermost surface of the coverplate body 1, at the lateral edges. The flanges 3 run the full length of the lateral edges, defining a capillary gap 4 or channel that extends the full length of the coverplate body 1. The flanges 3 project approximately 50 μm from the lowermost surface. The width of the capillary gap 4 corresponds approximately to the width of a standard glass microscope slide.

In an exemplary embodiment, the flanges 3 are formed from an adhesive label that is adhered to the uppermost surface of the coverplate body 1 and wraps around and under the lateral edges of the coverplate body 1 to form the lateral flanges 3. The magnetic shim 2 is secured between the uppermost surface of the coverplate body 1 and the adhesive label.

FIG. 2 shows an exemplary embodiment of the coverplate assembly. The coverplate body 1 is assembled with a detachable magnet 5. The magnet 5 forms a handle or knob which is a cylindrical body with a circular plate attached to each planar face of the cylindrical body. The magnet 5 is applied to the magnetic shim 2 of the coverplate body 1 (i.e., the magnet 5 is applied to the uppermost surface). The attached magnet 5 assists in the handling and manipulation of the coverplate assembly.

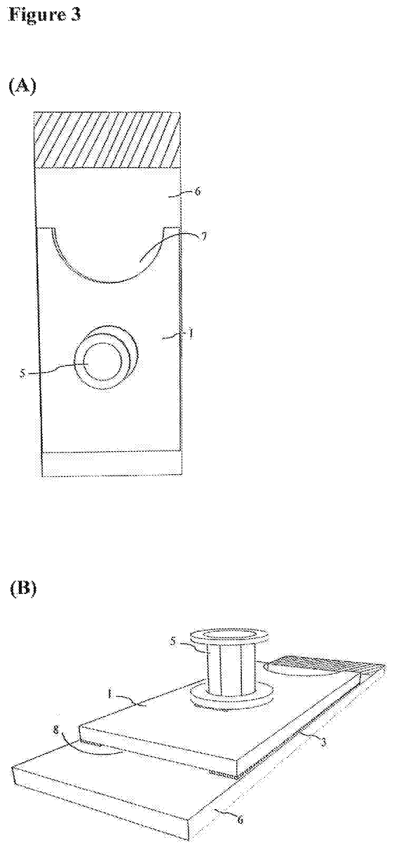

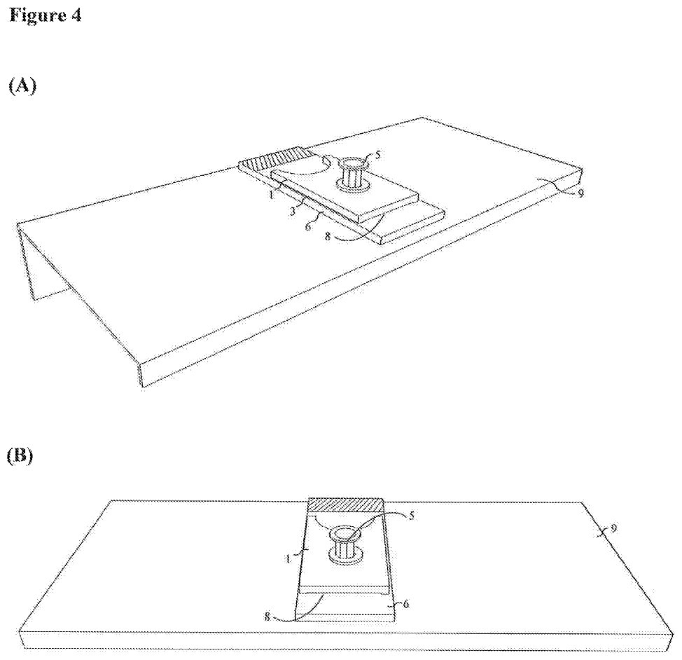

FIG. 3 provides an example of how the coverplate assembly is assembled with a microscope slide 6. The coverplate assembly is aligned onto the sample-receiving surface of the microscope slide 6, such that the lateral edges of the coverplate body 1 align with the lateral edges of the microscope slide 6. In alternative embodiments, the coverplate body 1 may be smaller than the width of the microscope slide 6 and thus the lateral edges will not be aligned.

The lateral flanges 3 of the coverplate assembly are in contact with the lateral edges of the sample-receiving surface of the microscope slide 6. The U-shaped notch 7 of the coverplate body 1 is positioned closest to the non-sample-receiving end of the slide 6. A capillary gap 8 is formed between the coverplate body 1 and the sample-receiving surface of the microscope slide 6.

FIG. 4 illustrates the coverplate assembly assembled on a microscope slide 6 and affixed to a magnetic rotatable member 9. The coverplate body 1 and microscope slide 6 are sandwiched between the magnetic rotatable member 9 and the coverplate magnet 5. The rotatable member 9 is a rotatable, flat magnetic steel platform with two perpendicular arms extending in the same direction. The first arm is longer and is configured to attach to a frame. The second arm is shorter, allowing the platform to tilt from an upright position (where the platform is substantially horizontal) to an inclined position (where the platform is inclined and the second arm contacts the frame).

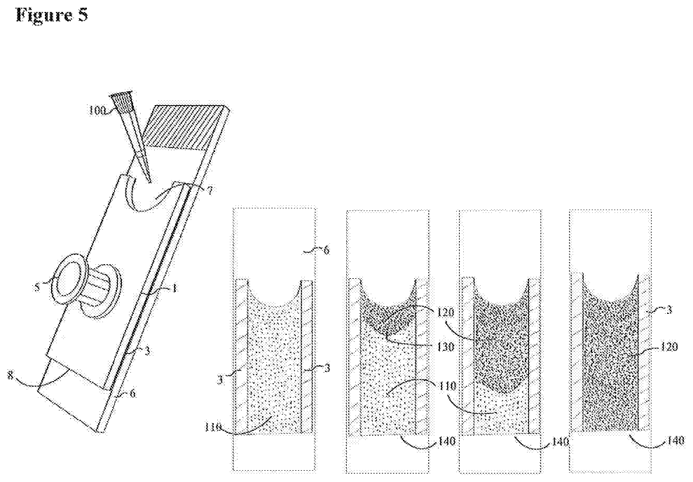

FIG. 5 illustrates the operation of the coverplate assembly when assembled with a magnetic counterpart, such as the magnetic rotatable member. For representation purposes the magnetic counterpart is not shown. The assembly illustrated includes a microscope slide 6 and a coverplate assembly (comprising the coverplate body 1, the magnet 5 and the two parallel lateral flanges 3). When the slide 6 is inclined, the U-shaped notch 7 forms a ledge.

Liquid reagent is dispensed from a dispensing nozzle 100 onto the ledge, which flows into the capillary gap 8 by capillary (surface tension) effect.

The sequence illustrations next to the representation of the assembly show, from left to right, an assembly where the gap is filled with a first liquid 110 and the progressive displacement of that liquid 110 by a second liquid 120 introduced onto the ledge, the boundary between the two liquids being shown at 130. The first liquid 110 is shown as being discharged from the gap as drops falling from the lower end of the coverplate. Thus, a sequence of liquids is brought into contact, successively, with the biological sample which is adhered to the microscope slide 6 and positioned within the gap 8 between the microscope slide 6 and the face of the coverplate.

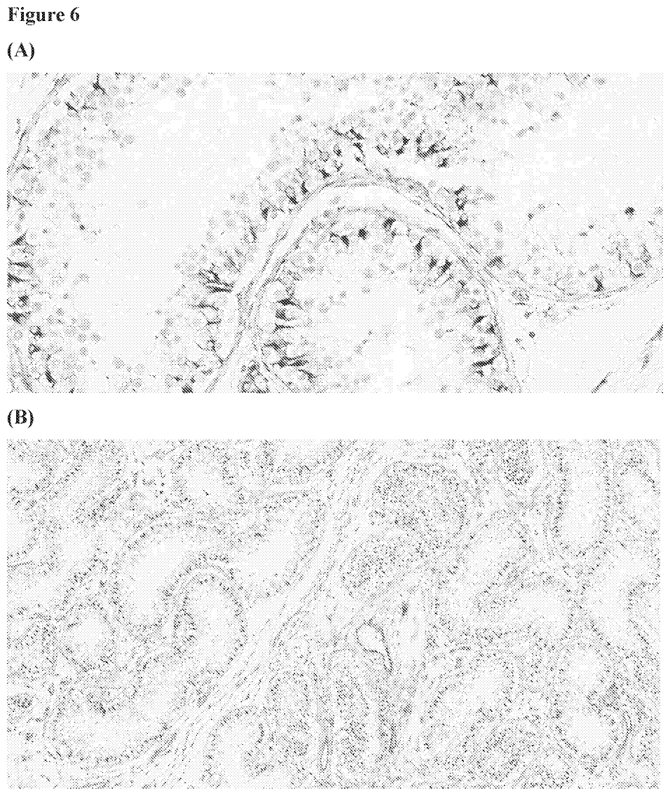

An example of slide staining using the coverplate assembly and the slide staining apparatus is shown in FIG. 6. A microscope slide with a formalin fixed, paraffin embedded testis tissue slice was placed onto the magnetic platform of a slide staining apparatus in an upright position. Water was pipetted onto the surface of the tissue slice. A coverplate assembly was placed over the tissue slice, securing the coverplate body to the slide through the magnetic interaction of the magnet with the magnetic platform, to form the capillary gap. The magnetic platform was rotated to the slide draining position. 70 μl of anti-vimentin primary antibody was applied to the notch of the coverplate and the slide was incubated for 1 h. Washing reagent was then sequentially added to the notch to wash the sample. Horseradish peroxidase (HRP) secondary antibody was applied to the notch of the coverplate and the slide was incubated for 1 h. Washing reagent was then sequentially added to the notch to wash the sample. The tissue was then counterstained with haematoxylin, washed and imaged.

### EXAMPLE 1

In a preferred embodiment, the microscope slide is placed onto a horizontal, magnetic steel platform with the biological sample uppermost. Water is placed on the uppermost aspect of the slide. The coverplate is positioned onto the microscope slide with its two, laterally positioned flanges face down to create a thin (capillary action dimensioned) chamber between the coverplate and the biological sample attached to the microscope slide (this chamber is now filled with water with no air). The coverplate body is held in position by the application of a magnet onto the uppermost surface of the coverplate. The assembled microscope slide and magnetically held coverplate and magnetic platform are collectively rotated into a non-horizontal position. The wash liquids and liquid reagents are applied to the uppermost angle formed by the thickness of the coverplate against the microscope slide. The in situ reagent is replaced by each successive reagent due to gravity-assisted displacement; each of the reagents and washes are sequentially applied over a period of time in accordance with the staining protocol.

The coverplate can be a variety of shapes but the preferred shape is square or rectangular with a “cut-out” at its uppermost edge. This “cut-out” may, for example, be semi-circular or “v-shaped”. When in the non-horizontal position, by virtue of gravity, the coverplate “cut-out” prevents the freshly applied reagent from spilling up and over the lateral sides of the coverplate.

The dimensions of the coverplate are not determined by the dimensions of the slide (as is the case in other systems where capillary action/surface tension is employed). Practically, the coverplate is the same size as or smaller than the slide to ensure the capillary gap is formed. For practical use, the preferred dimensions of the coverplate body are:
A) 1 mm thick, 25 mm wide and 35 mm long, or
B) 1 mm thick, 25 mm wide and 25 mm long, or

The flanges on the slide-opposing flat surface are of the required thickness to create a capillary action/surface tension sized gap between the coverplate and the microscope slide—of the order of between 20 μm and 100 μm.

The flanges may be composed of, for example, tape, cured epoxy resin or paint (e.g., powder coated strips).

The described invention enables a significant reduction in the use of expensive reagent volume to less than 50 μl per slide (cf. 100 μl or greater for existing systems)—e.g., a 25 mm wide and 25 mm long coverplate body with lateral flanges each 2 mm wide and 30 μm thick creates a capillary gap of less than 20 μl between the microscope slide and the coverplate. In experiments, we have achieved reproducible good quality immunohistochemical staining by using individual, successive reagent volumes of 25 μl for a coverplate of this size.

There may be multiple (i.e., more than two) parallel flanges positioned from top to bottom to create multiple channels for the application of different reagents to the same biological sample.

For ease of use, the coverplate has a thin piece of magnetic material (e.g., shim) attached to the face which does not oppose the biological sample. This assists in the handling of the coverplate, i.e., the coverplate can be readily picked up from the laboratory bench by the magnet that is then used to place the coverplate onto the horizontal microscope slide and hold the assemblage in place on the rotatable platform.

The rotatable platform is within a box that has a lid. With the addition of water in its base, this closed box serves as a humidified chamber to prevent reagent solvent evaporation. The box also serves as a drip-tray for the applied reagents and, for convenience, may have a pluggable drain hole in its base.

Because the microscope slide is hydrophilic, the opposing surface of the coverplate may be either hydrophilic or hydrophobic.

### EXAMPLE 2

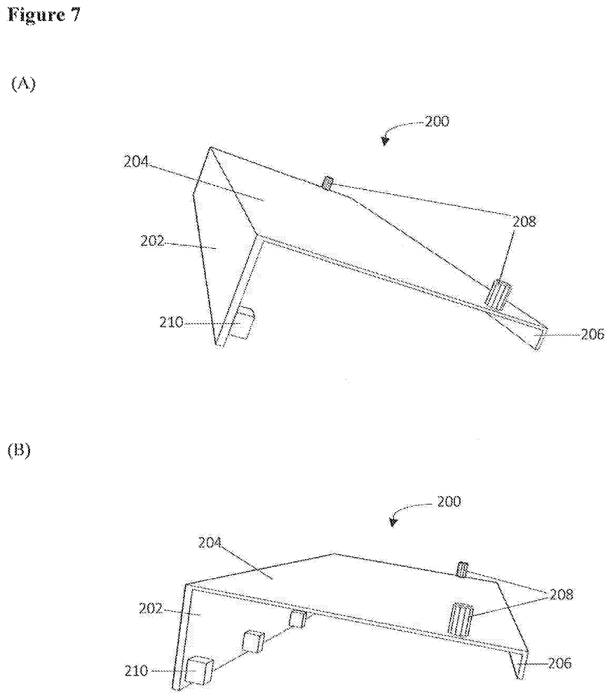

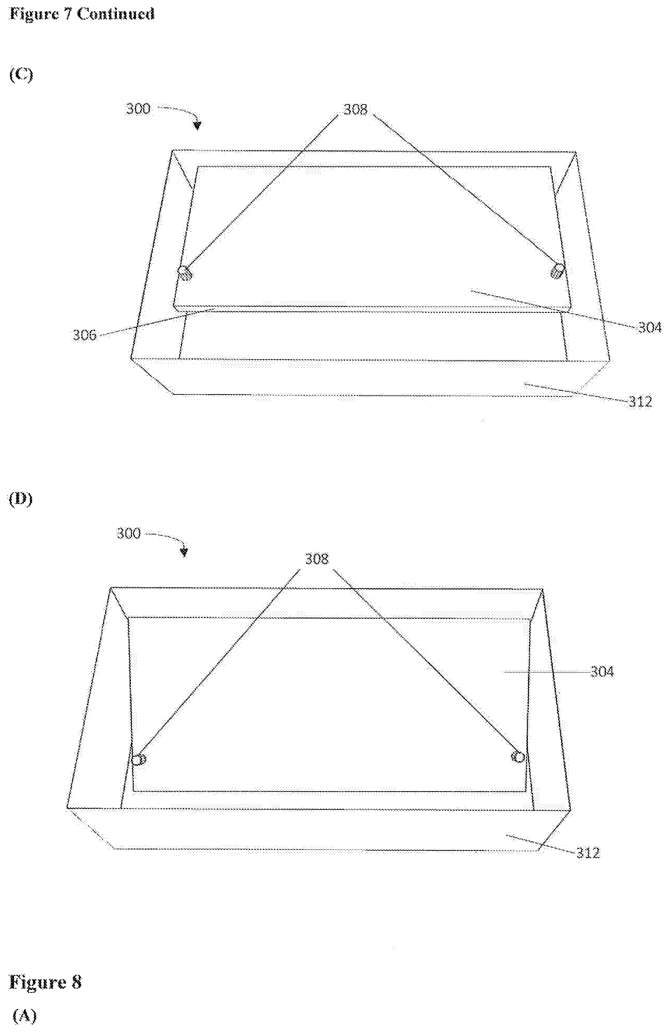

FIGS. 7A and 7B show an exemplary embodiment of the rotatable member 200. The rotatable member 200 is a sheet of magnetic material, such as steel, with a middle portion 204 flanked by a first arm 202 and a second arm 206. The first and second arms 202, 206, extend perpendicular to the middle portion 204 in the same direction. The first arm 202 is longer than the second arm 206. The uppermost surface of the middle portion 204 provides a platform for mounting a plurality of microscope slides. Magnets 208 can be attached to the magnetic platform (uppermost surface of the middle portion 204) to function as handles or to function in affixing the microscope slides to the platform. Four magnets 210 can be attached to the first arm 202, on the side that is facing the second arm 206. These magnets 210 function in connecting the rotatable member to the frame. Typically the depth of the first arm (202) is approximately 50 mm, and the second arm (206) is approximately 15 mm. The length of the middle portion is typically 70 mm and width of the rotatable member is approximately 255 mm.

FIGS. 7C and 7D show an exemplary embodiment of the rotatable member mounted on the frame 312. The frame 312 is an open-topped hollow cuboidal box made from a non-magnetic material. The box is typically approximately 110×265 mm×75 mm. The base of the box has a small aperture in one corner that is stoppered with a rubber bung. One side of the box has attached magnets running along the lower edge for cooperation with the magnets of the first arm of the rotatable member. The rotatable member is positioned inside the box, with the first arm in contact with the side of the box with attached magnets. The first arm is effectively sandwiched between the magnets of the first arm on one side, and the frame 312 and the magnets on the frame 312 on the other side. This magnetic interaction maintains the rotatable member in the upright slide staining position, i.e., slides that are mounted on the rotatable member are horizontal (shown in FIG. 7C). The handles 308 can be used to detach the first arm from the frame 312, tilting the rotatable member downwards until the second arm 306 of the rotatable member contacts the base of the frame 312. This places the rotatable member in the slide draining position, i.e., slides that are mounted on the rotatable member are inclined so that liquid drains from the slides (shown in FIG. 7D). The rotatable member can be rotated back to the slide staining position by pulling the handles 308 about the axis of the first arm, which reconnects the magnets located on the first arm to the frame 312.

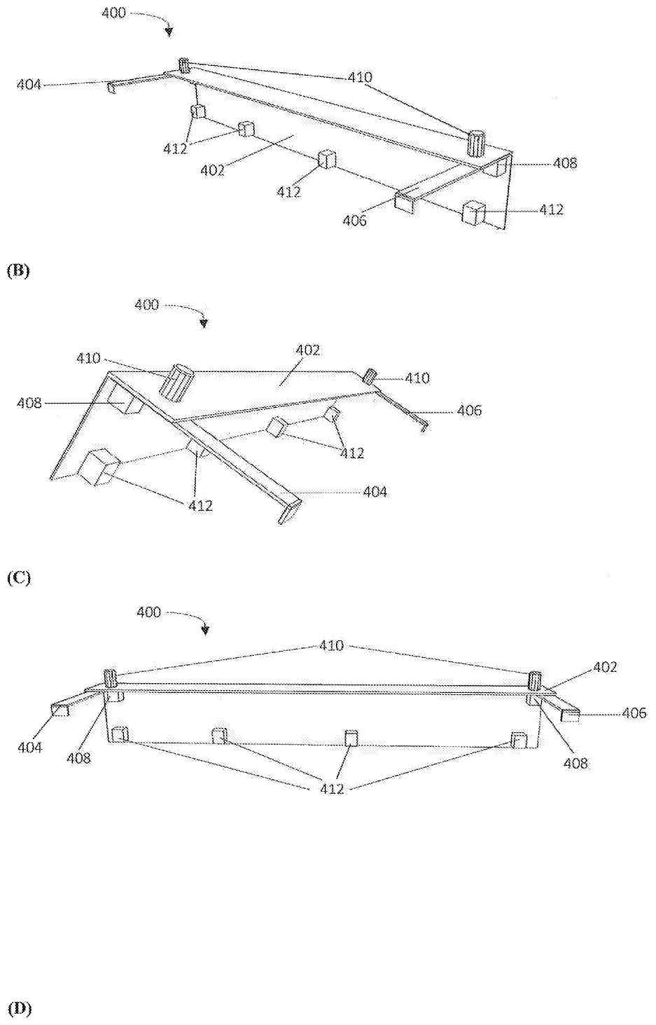

FIG. 8 shows an exemplary embodiment of the rotatable member 400 having a detachable section. The rotatable member 400 has a first portion 402 which is an elongate rectangular plate made form a magnetic material, such as steel. Magnets 412 are attached to the inner surface of the first portion 402 for cooperation with the magnets on the frame. A longitudinal edge of the first portion 402 is connected to a longitudinal edge of a second portion, where the second portion is perpendicular to the first portion 402. The second portion has a magnetic elongate rectangular portion and two non-magnetic or magnetic lateral overhanging arms 404, 406 to define a rectangular cut-out. Magnets 408 are attached to the inner surface of lateral overhanging arms 404, 406 for cooperation with a magnetic detachable section. FIG. 8D shows the rotatable member mounted on the frame. The magnets attached to the inner surface of the first portion cooperate with the magnets attached to the frame to hold the rotatable member in the upright slide-staining position. As shown in FIG. 8D, a plurality of microscope slides 514 can be mounted on the rotatable member. Magnets 510 are used to sandwich the non-staining ends of the slides between the magnetic elongate rectangular portion (of the second portion of the rotatable member) and the magnets 510. The slides 514 therefore overhang the rectangular cut out. This configuration is suitable for staining with non-precious reagents, as larger volumes of reagent can be applied to the slides and drained from the slides. If precious staining is necessary, a magnetic rectangular plate 616 can be attached to the outer surface of the second portion of the rotatable member, as shown in FIG. 8E and F. The magnetic plate 616 cooperates with the magnets 608 attached to the inner surface of the lateral overhanging arms. The magnetic plate 616 is typically the same length as the rotatable member and converts the rotatable member to a platform for supporting microscope slides along their full length. This configuration is suitable for use with the coverplate assembly described herein.

### EXAMPLE 3

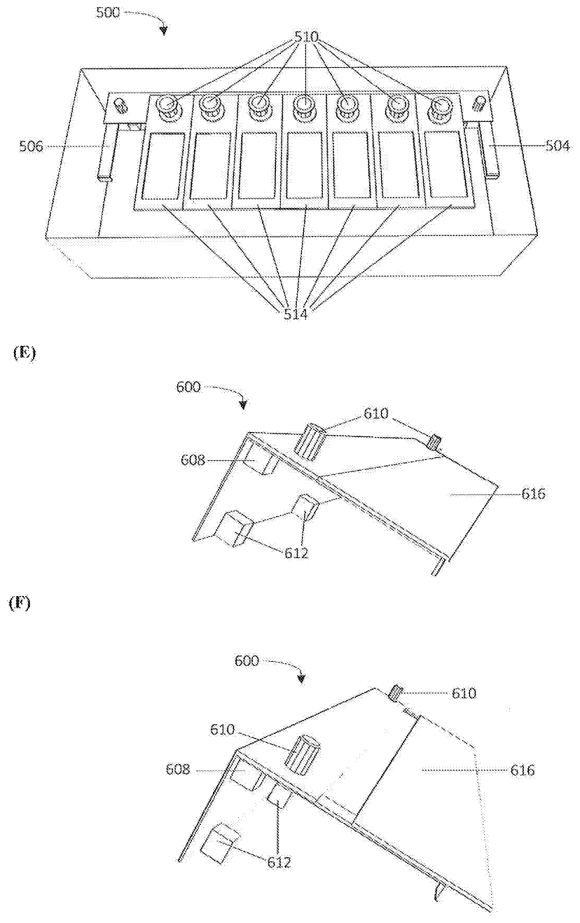

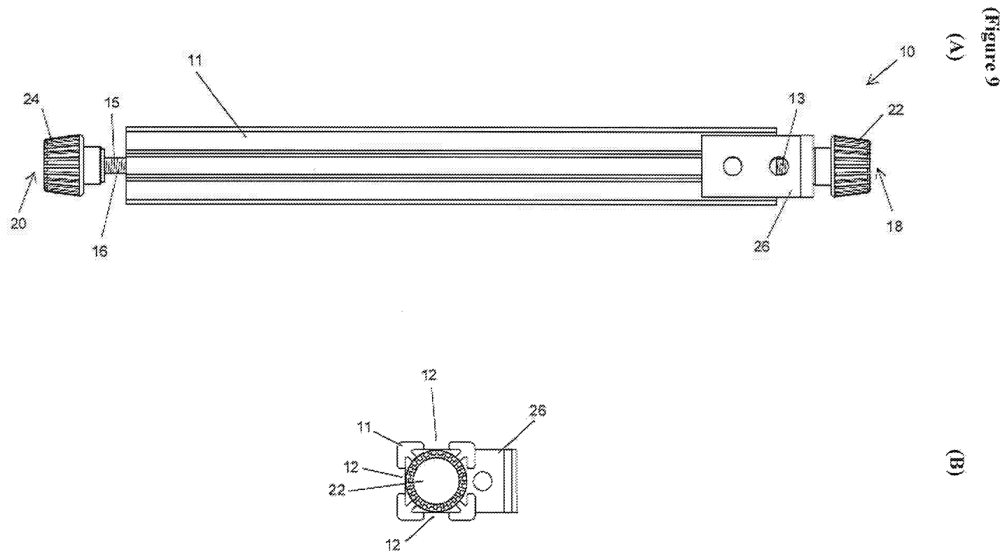

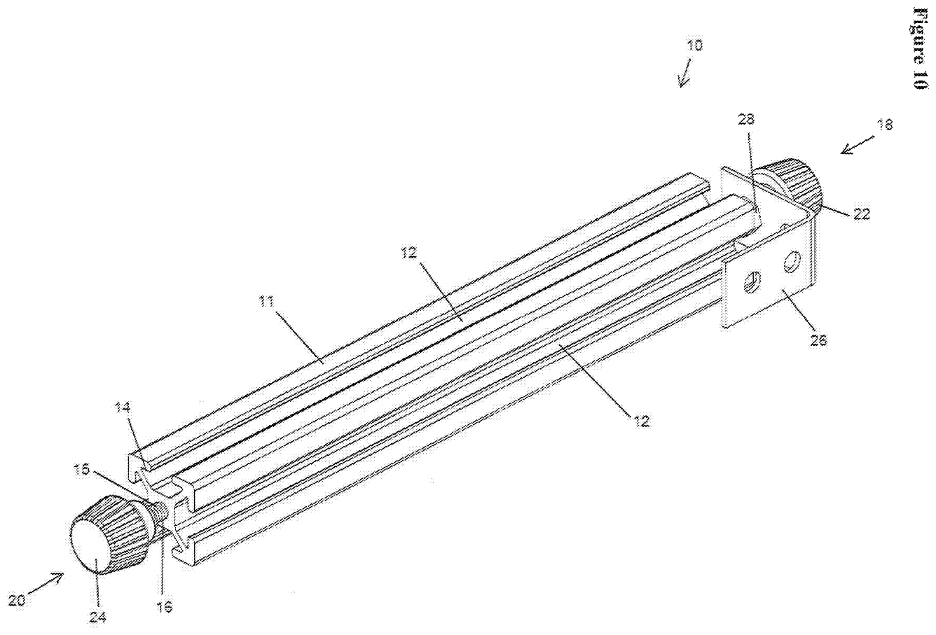

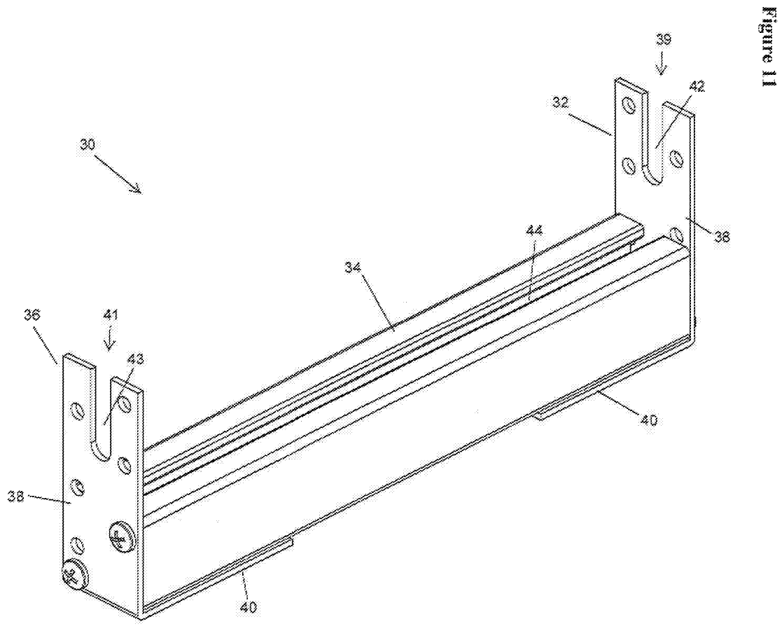

FIGS. 9A, 9B and 10 show an exemplary embodiment of the rotatable member (10). The rotatable member (10) is an elongate aluminium bar (11) having a flanged cruciform cross-section creating a groove (12) in each surface of the bar (11). The grooves (12) run along the longitudinal length of the bar (11). Each groove (12) has an inwardly extending flange (14) against which microscope slides can be wedged so as to retain their position in the groove (12). The elongate aluminium bar (11) may be approximately 170 mm in length, which is suitable for mounting six microscope slides. Alternatively, the elongate aluminium bar (11) may be approximately 406 mm in length, which is suitable for mounting 15 microscope slides.

The rotatable member (10) includes a shaft (16) running through the bar (11) along the longitudinal axis of the bar (11). The shaft (16) includes two threaded shank portions (13, 15) which protrude from each of the first (18) and second (20) ends of the bar (11) respectively. A first handle (22) and a second handle (24) are screwed to each threaded shank portion (13, 15) such that the first and second handles (22, 24) are spaced apart from the first and second ends (18, 20) of the elongate bar (11), respectively. The first and second handles (22, 24) are made from solvent resistant plastic (i.e. HDPE or polypropylene).

The first and second handles (22, 24) each have a substantially frustoconical portion for direct rotation by the user. The base of each frustoconical portion has a threaded hole for receiving the threaded shank portions (13, 15) of the shaft (16). This enables the first and second handles (22, 24) to be tightened onto and loosened from the shaft (16) by screwing and unscrewing, respectively.

An L-shaped guide arm (26) is positioned on the first threaded shank portion (13) of the shaft (16), sandwiched between the first handle (22) and a threaded nut (28). Accordingly, the rotational motion of the L-shaped guide arm (26) about the axis of rotation of the rotatable member (10) can be coupled to, or decoupled from, the rotational motion of the shaft (16) by tightening, or loosening, the first handle (22), respectively. The L-shaped guide arm (26) is a rectangular plate of steel that has been bent such that a first radially extending portion and second axially extending portion of the L-shaped guide arm (26) are equal in length and perpendicular. The length of the first and second portions of the L-shaped guide arm (26) are each 30 mm which is greater than the width of the elongate bar (11).

Two evenly-spaced apertures extend through the first portion of the L-shaped guide arm (26), each of which may be used to position the L-shaped guide arm (26) onto the first threaded shank portion (13) so as to vary the degree of interference created by the L-shaped guide arm (26) in use.

FIG. 9 shows an exemplary embodiment of the frame (30). The frame is made of aluminium and steel. The frame (30) has a width greater than the length of the elongate bar of the rotatable member. For instance, a six-slide apparatus may have a frame width of 177 mm and a bar length of 170 mm, whereas a fifteen-slide apparatus may have a frame width of 416 mm and a bar length of 406 mm. The frame (30) consists of a first L-shaped bracket (32), an elongate base member (34) and a second L-shaped bracket (36), all of which are of equal width. The first and second L-shaped brackets (32, 36) are identical to each other and each have a vertical portion (38) and a horizontal portion (40). The vertical and horizontal portions (38, 40) are of equal length. The distal ends of the vertical portions (39, 41) have a U-shaped receiving slot (42, 43) that extends approximately 40% along the length of the vertical portion (38).

The elongate base member (34) is a hollow rectangular cuboid. The base member (34) is connected to and sandwiched between the first and second L-shaped brackets (32, 36). The base member (34) contacts both the vertical and horizontal portions (38, 40) of the first and second brackets (32, 36). The upper surface of the cuboid (i.e. opposite to the surface which contacts the horizontal portions (40)) has an aperture (44) running along its longitudinal length.

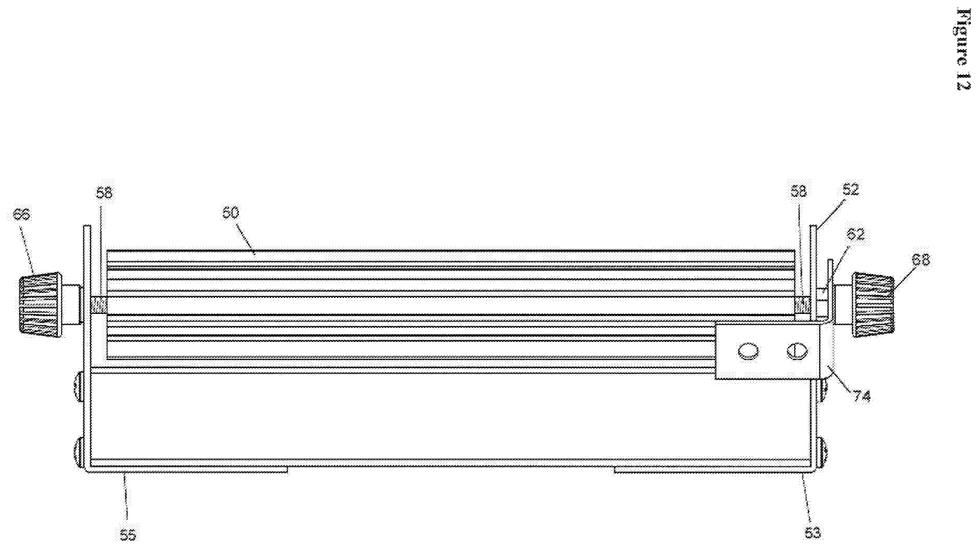

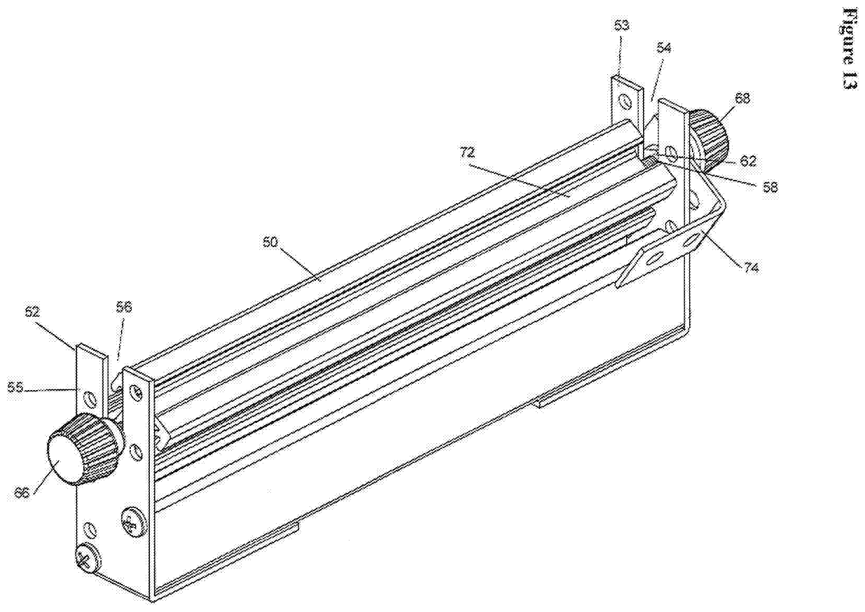

FIGS. 12 and 13 show an exemplary embodiment of the rotatable member (50) mounted on the frame (52). The U-shaped receiving slots (54, 56) of the first and second L-shaped brackets (53, 55) are wider and longer than the diameter of the shaft (58) of the rotatable member (50), allowing the U-shaped receiving slots (54, 56) to receive the shaft (58). The vertical portion of the first L-shaped bracket (53) is sandwiched between a threaded nut (62) and the first end of the rotatable member (50). The vertical portion of the second L-shaped bracket (55) is sandwiched between the second end of the rotatable member (50) and the second handle (66).

To set up the apparatus for use, a test slide is placed into the groove (72) of the rotatable member (50). The L-shaped guide arm (74) is held stationary while the first handle (68) is loosened to decouple the rotation of the L-shaped guide arm (74) from the rotation of the shaft (58). The L-shaped guide arm (74) is then rotated such that a lower edge of the L-shaped guide arm (74) abuts the frame (52), inhibiting further rotation in one direction. The rotatable member (50) is rotated relative to the frame (52) and the L-shaped guide arm (74) until the test slide is substantially horizontal (i.e. the slide treatment position). The first handle (68) is tightened, such that the L-shaped guide arm (74) is tightly clamped between the first handle (68) and the threaded nut (62), which recouples the rotation of the L-shaped guide arm (74) to the rotation of the shaft (58).

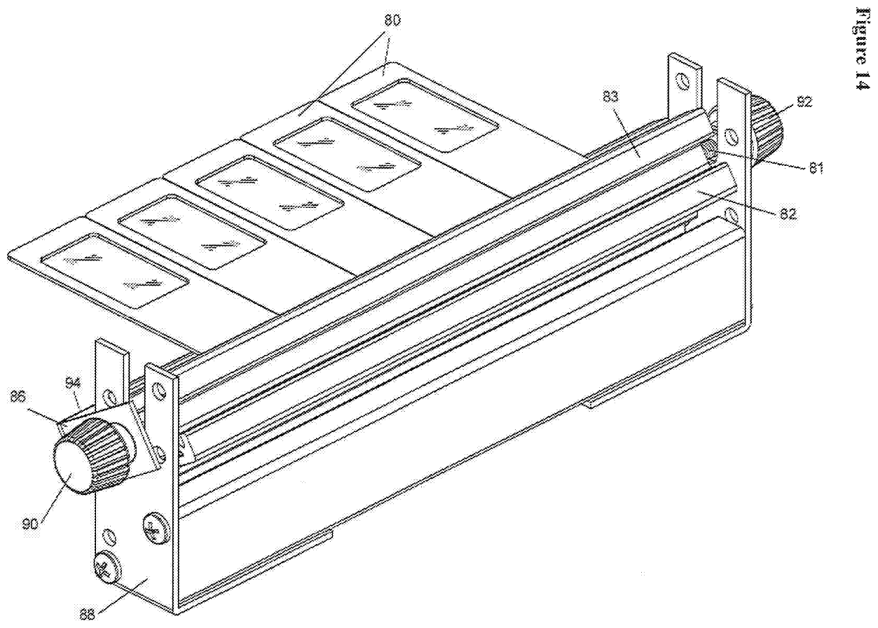

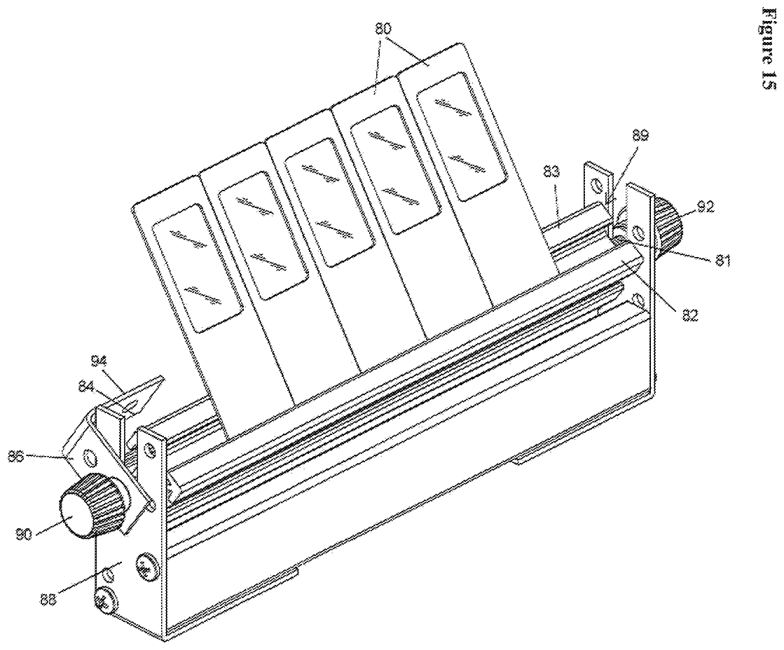

FIGS. 14 and 15 show the rotatable mechanism of the apparatus. In the slide treatment position (as shown in FIG. 12), the slides (80) mounted on the rotatable member (82) are substantially horizontal and the lower edge (84) of the L-shaped guide arm (86) abuts the frame (88). Rotation of the first handle (90) in a first direction causes equal rotation of the shaft (81), the elongate bar (83), the slides (80), the L-shaped guide arm (86) and the second handle (92). Rotation is impeded when the upper edge (94) of the L-shaped guide arm (86) abuts the frame (88), such that the slides are inclined with respect to the horizontal, facilitating the drainage of any fluid from the slide (i.e., the slide draining position, as shown in FIG. 15).

If desired, the apparatus can be locked at any angle of rotation between (and including) the slide treatment position and the slide draining position by tightening the second handle (92), such that the vertical portion of the second L-shaped bracket is tightly clamped between the second end (89) of the elongate bar (83) and the second handle (92). The apparatus is unlocked by loosening the second handle (92).

Rotation of the first handle (90) in a second direction (that is opposite to the first direction) causes equal rotation of the shaft (81), the elongate bar (83), the slides (80), the L-shaped guide arm (86) and the second handle (92). Rotation is impeded when the lower edge (84) of the L-shaped guide arm (86) abuts the frame (88). The slides (80) are thus returned to the slide treatment position.

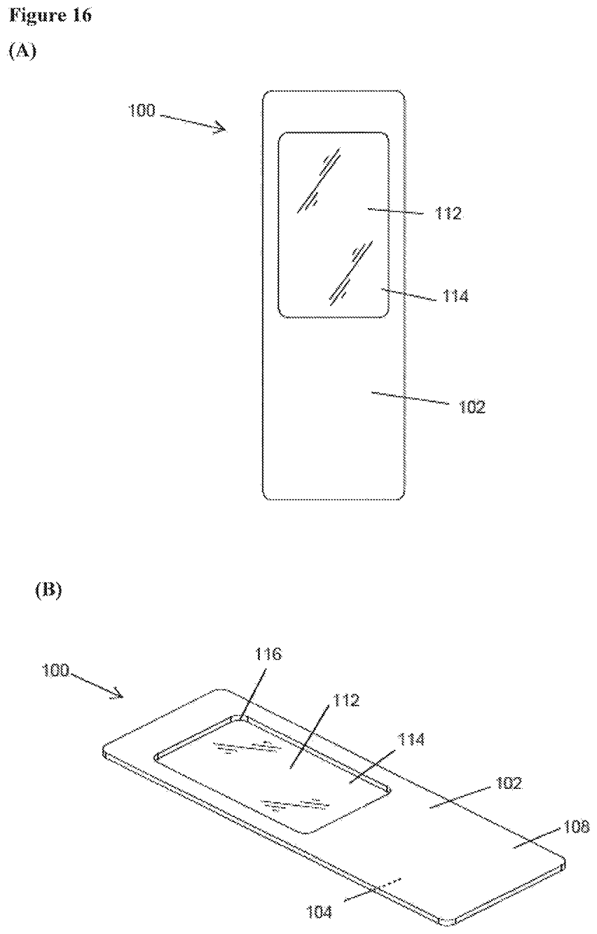

FIGS. 16A and 16B show an exemplary microscope slide (100) that may be used in the present invention. The slide (100) has a base (102) which is a rectangular aluminium plate of dimensions 75×25×1 mm. The base (102) has a first surface (104) on the first side and a second surface (108) on the second side. An aperture (112) extends through the base (102) from the first side to the second side. The aperture (112) is substantially rectangular with rounded corners, with dimensions 35×20 mm. A coverslip (114) is provided which covers the aperture (112) on the first side (104). The coverslip (114) is formed from glass (though in some embodiments it may be transparent plastic). The coverslip (114) is placed on the first surface (104) so as to completely overlay the aperture (112). Alternatively, the coverslip (114) can be formed as an integral window flush with the first surface (104). This arrangement forms a well (116) in the microscope slide (100) that is suitable for receiving a sample and/or treatment liquid, such as staining reagents. The exemplary microscope slide has been previously described in WO 2015/132583 (see for example the passage on page 12, lines 7 to 20), incorporated in its entirety.

### Clauses

1. A method of preparing a plurality of microscope slides, the method comprising the steps of:
   (a) optionally applying one or more samples to the plurality of microscope slides;
   (b) mounting the plurality of microscope slides on a rotatable member, the rotatable member being rotatable between a first position and a second position about a rotational axis;
   (c) applying one or more treatment liquids to the plurality of microscope slides in the first position; and
   (d) rotating the rotatable member to a second position to effect removal of the one or more treatment liquids;
   (e) optionally drying the plurality of microscope slides;
   (f) optionally repeating steps one or more of steps (c) to (e);
   (g) optionally applying sealant to the plurality of microscope slides;
   (h) optionally removing the plurality of microscope slides from the rotatable member;
   wherein the rotatable member comprises a fastener to affix the plurality of microscope slides to the rotatable member.
2. A method according to clause 1, wherein the rotatable member is connected to, and rotatable relative to, a frame.
3. A method according to clause 2, wherein the rotatable member is disconnectable from the frame.
4. A method according to any preceding clause wherein the rotatable member is an elongate bar and the rotational axis is along the longitudinal axis of the elongate bar, optionally wherein the fastener is along the length of the elongate bar.
5. A method according to any preceding clause, wherein the fastener comprises one or more grooves or slots, optionally wherein the one or more grooves or slots comprises a flange.
6. A method according to any preceding clause, wherein the fastener comprises a magnet.
7. A method according to any preceding clause, wherein rotatable member is operably connected to a locking mechanism to prevent rotation of the rotatable member.
8. A method according to any preceding clause, wherein rotatable member is operably connected to a rotation guide configured to constrict rotation of the rotatable member about the rotational axis.
9. A method according to any preceding clause, wherein the rotatable member further comprises one or more conduits for the removal of the one or more treatment liquids.
10. A method according to any preceding clause, wherein the plurality of microscope slides each comprise:
   a body;
   an aperture within said body; and
   a viewing window;
   wherein the viewing window seals said aperture to create a well, said well configured to receive the sample and/or the one or more treatment liquids.
11. A method according to any preceding clause, further comprising the step of applying one or more treatment liquids to the plurality of microscope slides in the second position, typically wherein the treatment liquid is a solvent.
12. An apparatus for preparing a plurality of microscope slides, the apparatus comprising:
   a frame; and
   a rotatable member connected to, and rotatable relative to, the frame;
   wherein the rotatable member is rotatable between a first position and a second position about a rotational axis;
   wherein the rotatable member comprises a fastener to affix the plurality of microscope slides to the rotatable member.
13. An apparatus according to clause 12, wherein the rotatable member is disconnectable from the frame.
14. An apparatus according to clause 12 or 13, wherein the rotatable member is an elongate bar and the rotational axis is along the longitudinal axis of the elongate bar, optionally wherein the fastener is along the length of the elongate bar.
15. An apparatus according to any one of clauses 12 to 14, wherein the fastener comprises one or more grooves or slots, optionally wherein the one or more grooves or slots comprises a flange.
16. An apparatus according to any one of clauses 12 to 15, wherein the fastener comprises a magnet.
17. An apparatus according to any one of clauses 12 to 16, wherein the rotatable member further comprises one or more conduits for the removal of the one or more treatment liquids.
18. An apparatus according to any one of clauses 12 to 17, wherein the apparatus further comprises a locking mechanism to prevent rotation of the rotatable member.
19. An apparatus according to any one of clauses 12 to 18, wherein rotatable member is operably connected to a rotation guide to restrict rotation of the rotatable member about the rotational axis.
20. An apparatus according to any one of clauses 12 to 19, further comprising a plurality of microscope slides.
21. An apparatus according to clause 20, wherein the plurality of microscope slides each comprise:
   a body;
   an aperture within said body; and
   a viewing window;
   wherein the viewing window seals said aperture to create a well, said well configured to receive the sample and/or the one or more treatment liquids.
22. An apparatus according to any one of clauses 12 to 21, further comprising at least one dispenser configured to deliver the one or more treatment liquids to the plurality of microscope slides.
23. An apparatus according to clause 22, wherein the at least one dispenser comprises a plurality of dispensing apertures.
24. An apparatus according to clause 23, wherein the dispensing apertures are spaced apart such that, in use, the dispensing apertures align with the plurality of microscope slides.
25. An apparatus according to any one of clauses 12 to 24, further comprising: a collection vessel, a heating element, a cooling element, a microscope, or combinations thereof.

1. A coverplate assembly for a microscope slide, the coverplate comprising:
a coverplate body;
at least two flanges arranged on a surface of the coverplate body; and
a magnet or a magnetic material configured to cooperate with a magnetic counterpart to affix the coverplate to a microscope slide, thereby providing a capillary gap between the coverplate body and the microscope slide.

2. A coverplate assembly according to claim 1, wherein the at least two flanges are lateral strips of a hydrophobic material, optionally wherein the at least two flanges are made of tape, cured epoxy resin or paint.

3. A coverplate assembly according to claim 1 wherein the at least two flanges are formed by precision milling or etching the coverplate to create a channel and the flanges.

4. A coverplate assembly according to claim 1, wherein the at least two flanges are parallel.

5. A coverplate assembly according to claim 1, wherein the coverplate body comprises a notch between the flanges.

6. A coverplate assembly according to claim 5, wherein the notch is semi-circular or v-shaped.

7. A coverplate assembly according to claim 1, wherein the magnet or magnetic material is integral to the coverplate body.

8. A coverplate assembly according to claim 1, wherein the magnet or the magnetic material is not integral to the coverplate body.

9. A coverplate assembly according to claim 1, wherein the coverplate body comprises a magnetic shim that cooperates with the magnet.

10. A kit comprising at least one coverplate assembly according to claim 1 and at least one microscope slide.

11. A kit according to claim 10, wherein the at least one microscope slide comprises:
a slide body;
an aperture within said slide body; and
a viewing window;
wherein the viewing window seals said aperture to create a well, said well configured to receive a sample and/or one or more treatment liquids.

12. An apparatus for preparing a plurality of microscope slides, the apparatus comprising:
a frame; and
a rotatable member connected to, and rotatable relative to, the frame;
wherein the rotatable member is rotatable between a first position and a second position about a rotational axis; and
wherein the rotatable member comprises a slide fastener to affix the plurality of microscope slides to the rotatable member.

13. An apparatus according to claim 12, wherein the slide fastener comprises a magnet, optionally wherein the rotatable member is made from a magnetic material and the slide fastener is integral thereto.

14. An apparatus according to claim 13, further comprising at least one magnetic counterpart for the slide fastener, wherein, in use, the plurality of microscope slides are positioned between the slide fastener and the at least one magnetic counterpart.

15. An apparatus according to claim 12, wherein the rotatable member is connected to the frame magnetically.

16. An apparatus according to claim 12, wherein the rotatable member comprises a platform configured to support the plurality of microscope slides.

17. An apparatus according to claim 16, wherein the platform comprises a detachable section, such that when the section is attached, the slides are supported along their length by the platform, whereas when the section is detached, the slides overhang the platform.

18. An apparatus according to claim 12, wherein the rotatable member has a first elongate edge in contact with the frame, wherein the rotational axis of the rotatable member is along said elongate edge.

19. An apparatus according to claim 18, wherein the rotatable member has a second elongate edge that abuts the frame in the second position and does not abut the frame in the first position.

20. An apparatus according to claim 12, wherein the frame is a container and the rotatable member is positioned inside the container, optionally wherein the container comprises a detachable bung.

21. An apparatus according to claim 12, further comprising: a lid, a collection vessel, a heating element, a cooling element, a liquid dispenser, a microscope, or a combination thereof.

22. An apparatus according to claim 12, further comprising a plurality of microscope slides.

23. An apparatus according to claim 22, wherein the plurality of microscope slides each comprise:
a slide body;
an aperture within said slide body; and
a viewing window;
wherein the viewing window seals said aperture to create a well, said well configured to receive a sample and/or one or more treatment liquids.

24. A kit comprising a coverplate assembly according to claim 1 and an apparatus according to for preparing a plurality of microscope slides comprising:
a frame; and
a rotatable member connected to, and rotatable relative to, the frame;
wherein the rotatable member is rotatable between a first position and a second position about a rotational axis; and
wherein the rotatable member comprises a slide fastener to affix the plurality of microscope slides to the rotatable member.

25. A method of preparing a plurality of microscope slides, the method comprising the steps of:
(a) optionally applying one or more samples to the plurality of microscope slides;
(b) mounting the plurality of microscope slides on a rotatable member, the rotatable member being rotatable between a first position and a second position about a rotational axis;
(c) applying one or more treatment liquids to the plurality of microscope slides in the first position; and
(d) rotating the rotatable member to a second position to effect removal of the one or more treatment liquids;
(e) optionally drying the plurality of microscope slides;
(f) optionally repeating steps one or more of steps (c) to (e);
(g) optionally applying sealant to the plurality of microscope slides;
(h) optionally removing the plurality of microscope slides from the rotatable member;
wherein the rotatable member comprises a fastener to affix the plurality of microscope slides to the rotatable member.

26. A method according to claim 25, the method further comprising:
detaching a section of the rotatable member such that the method is suitable for non-precious staining; and/or attaching a section of the rotatable member such that the method is suitable for precious staining.

27. A method according to claim 25 or claim 26, the method further comprising:
affixing to at least one of the plurality of microscope slides a coverplate assembly for a microscope slide comprising:
a coverplate body;
at least two flanges arranged on a surface of the coverplate body; and
a magnet or a magnetic material configured to cooperate with a magnetic counterpart to affix the coverplate to a microscope slide, thereby providing a capillary gap between the coverplate body and the microscope slide.
